(19) United States
(12) Patent Application Publication
(10) Pub. No.: US 2010/0328238 A1
(43) Pub. Date: Dec. 30, 2010

(54) INPUT DEVICE AND INPUT METHOD

(75) Inventor: Yuki SUGIUE, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/782,985

(22) Filed: May 19, 2010

(30) Foreign Application Priority Data
Jun. 30, 2009 (JP) 2009-154920

(51) Int. Cl. G06F 3/041

(52) U.S. Cl. 345/173

(57) ABSTRACT

An input device that inputs information corresponding to display of a display unit includes: an input unit that accepts a slide input in which a contact portion moves in a predetermined direction after being touched with the contact maintained, the input unit being configured by a plurality of input mechanisms that are adjacent to each other; slide input detecting means for detecting the slide input between the input mechanisms of the input unit; and selection means for selecting the information corresponding to a selection item displayed in the display unit in accordance with the slide input detected by the slide input detecting means.

### BACKGROUND OF THE INVENTION

1. Field of the Invention

The present invention relates to an input device and an input method, and more particularly, to an input device and an input method capable of configuring an input unit that occupies a small area and has a simple structure.

2. Description of the Related Art

As a character input technique, there is a technique in which, after a consonant alphabetic character (key) is touched on a software keyboard, a sliding action in any one of five directions from the touched position is accepted, and a vowel alphabetic character is determined in accordance with the direction (angle) (see JP-A-2005-275635).

### SUMMARY OF THE INVENTION

However, in the technique disclosed in JP-A-2005-275635, for example, even a key that is positioned on the rightmost side of the software keyboard may need to be slid to the right side. Accordingly, on the periphery of the area in which the software keyboard is displayed on a touch panel, an area for sliding is arranged. In addition, in a case where the above-described technique is applied to a hardware keyboard, sensors for each direction are disposed in each key, whereby the structure thereof becomes complicated.

Thus, it is desirable to configure an input unit so as to occupy a small area and have a simple structure.

According to an embodiment of the present invention, there is provided an input device that inputs information corresponding to display of a display unit. The input device includes: an input unit that accepts a slide input in which a contact portion moves in a predetermined direction after being touched with the contact maintained and is configured by a plurality of input mechanisms that are adjacent to each other; slide input detecting means for detecting the slide input between the input mechanisms, which are adjacent to each other, of the input unit; and selection means for selecting the information corresponding to a selection item displayed in the display unit in accordance with the slide input detected by the slide input detecting means.

It may be configured that the plurality of input mechanisms are disposed in a matrix shape, the slide input detecting means detects a first slide input that is a slide input between input mechanisms adjacent to each other in a predetermined direction, or detect a second slide input that is a slide input between the input mechanisms adjacent to each other in a direction perpendicular to the predetermined direction, and the selection means selects the information corresponding to the selection items displayed in the display unit in a predetermined order when the first slide input is detected by the slide input detecting means, or selects the information corresponding to the selection items displayed in the display unit in an order opposite to the predetermined order if the second slide input is detected.

The above-described input device may further include touch input detecting means for detecting a touch input in each of the input mechanisms. The selection means selects accompanying information that corresponds to the selection items displayed in the display unit and is accompanied by the information corresponding to the input mechanism, in which the touch input is detected by the touch input detecting means, in a predetermined order when the first slide input is detected, or selects the accompanying information corresponding to the selection items displayed in the display unit in an order opposite to the predetermined order if the second slide input is detected.

In the above-described input device, push input detecting means for detecting a push input in the input unit, and determination means for determining the accompanying information selected by the selection means as input information at a time when the push input is detected in the input mechanism by the push input detecting means may be further included.

The determination means may be configured to determine the accompanying information selected by the selection means as the input information when the touch input is released in the input mechanism.

It may be configured that the touch input detecting means detects the touch input in each of the input mechanisms to which a group of characters input for a character input are assigned, where the selection means selects characters included in the group of characters corresponding to the input mechanism in a predetermined order when the first slide input is detected, or selects the characters included in the group of characters in an order opposite to the predetermined order if the second slide input is detected, and the determination means then determines the character selected by the selection means as the input character when the push input is detected in the input mechanism.

In addition, it may be configured that the selection means selects conversion candidates for a character, which are displayed in the display unit, in a character input corresponding to the input mechanism in which the touch input is detected by the touch input detecting means in a predetermined order when the first slide input is detected, or selects the conversion candidates for the character displayed in the display unit in an order opposite to the predetermined order if the second slide input is detected, and the determination means then determines the conversion candidate for the character that is selected by the selection means when the push input is detected in the input mechanism.

It may be configured that the selection means selects formats of a character, which are displayed in the display unit, set in a character input corresponding to the input mechanism, in which the touch input is detected by the touch input detecting means, in a predetermined order when the first slide input is detected, or selects the formats of the character, which are is displayed in the display unit, in an order opposite to the predetermined order if the second slide input is detected, and the determination means then determines the format of the character that is selected by the selection means when the push input is detected in the input mechanism.

In addition, it may be configured that the touch input detecting means detects a touch input in each of the input mechanisms to which contents are assigned, the selection means selects content related information of the content, which is displayed in the display unit, corresponding to that input mechanism in a predetermined order when the first slide input is detected, or selects the content related information displayed in the display unit in an order opposite to the predetermined order if the second slide input is detected, and the determination means then determines the content related information that is selected by the selection means when the push input is detected in the input mechanism.

In the above-described input device, a supply means supplyies a command for displaying the content related information of the content corresponding to the input mechanism, in which the touch input is detected, in the display unit when the touch input is detected in any of the input mechanisms may be further included.

In addition, the supply means may be configured to supply a command for displaying the content corresponding to the input mechanism in a predetermined area of the display unit when the touch input for the predetermined time or more is detected in any of the input mechanisms.

In addition, the supply means may supply a command for newly assigning the content displayed in the display unit to the input mechanism in which the push input for a predetermined time or more is detected in any of the input mechanisms by the push input detecting means.

It may be configured that the touch input detecting means detects the touch input in each of the input mechanisms to which applications relating to contents viewing are assigned, the selection means selects parameters, which are displayed in the display unit, set by the application corresponding to the input mechanism in a predetermined order when a first slide input is detected, or selects the parameters displayed in the display unit in an order opposite to the predetermined order if the second slide input is detected, and the determination means determines the parameter that is selected by the selection means when the push input is detected in the input mechanism.

According to another embodiment of the present invention, there is provided an input method for an input device that inputs information corresponding to display of a display unit and includes an input unit that accepts a slide input in which a contact portion moves in a predetermined direction after being touched with the contact maintained and is configured by a plurality of input mechanisms adjacent to each other. The input method includes the steps of: detecting the slide input between the input mechanisms, which are adjacent to each other, of the input unit; and selecting the information corresponding to a selection item displayed in the display unit in accordance with the slide input detected in the detecting of the slide input.

According to one embodiment of the present invention, a slide input between input mechanisms, which are adjacent to each other, of the input unit is detected, and information corresponding to a selection item displayed in the display unit is selected in accordance with the detected slide input.

According to one embodiment of the present invention, an input unit that occupies a small area and has a simple structure can be configured.

### BRIEF DESCRIPTION OF THE DRAWINGS

FIG. 1 is a diagram showing an example of the external configuration of an input device according to an embodiment of the present invention.

FIG. 2 is a diagram illustrating the hardware configuration of an input unit.

FIG. 3 is a block diagram showing a configuration example of a mobile terminal device as an input device according to an embodiment of the present invention.

FIG. 4 is a diagram illustrating an information selecting operation of a mobile terminal device.

FIG. 5 is a flowchart illustrating a character input process of the mobile terminal device.

FIG. 6 is a diagram illustrating an input unit used for the character input process.

FIG. 7 is a flowchart illustrating a character selecting process of the mobile terminal device.

FIG. 8 is a diagram illustrating a display unit in the character input process.

FIG. 9 is a flowchart illustrating a conversion process of the mobile terminal device.

FIG. 10 is a diagram illustrating a display unit in a conversion process.

FIG. 11 is a diagram illustrating a slide input in the conversion process.

FIG. 12 is a flowchart illustrating a format setting process of the mobile terminal device.

FIG. 13 is a diagram illustrating a display unit in the format setting process.

FIG. 14 is a diagram illustrating a slide input in the format setting process.

FIG. 15 is a block diagram showing a configuration example of a remote controller as an input device according to an embodiment of the present invention and a corresponding television set according to an embodiment of the present invention.

FIG. 16 is a flowchart illustrating a program selecting process of the remote controller.

FIG. 17 is a diagram illustrating an input unit of the remote controller and a display unit of the television set in the program selecting process.

FIG. 18 is a flowchart illustrating a program related information selecting process of the remote controller.

FIG. 19 is a diagram illustrating selection items displayed in the display unit of the television set.

FIG. 20 is a diagram illustrating an input unit of the remote controller and a display unit of the television set in a program selecting process.

FIG. 21 is a diagram illustrating an input unit of the remote controller and a display unit of the television set in a program selecting process.

FIG. 22 is a diagram illustrating an input unit of the remote controller and a display unit of the television set in a program selecting process.

### DESCRIPTION OF THE PREFERRED EMBODIMENTS

Hereinafter, embodiments of the present invention will be described with reference to the accompanying drawings. The description of the embodiments will be made by way of application to some portable equipment such as a smartphone and a notebook PC to which touch control can be made and whose display language can be changed. The description will be presented in the following order.

1. Overview of Input Unit of Input Device according to Embodiment of Present Invention

2. First Embodiment (Character Input in Mobile Terminal Device)

3. Second Embodiment (Contents Selection in Television Set)

### 1. Overview of Input Unit of Input Device According to Embodiment of Present Invention

### [Example of External Configuration of Input Unit]

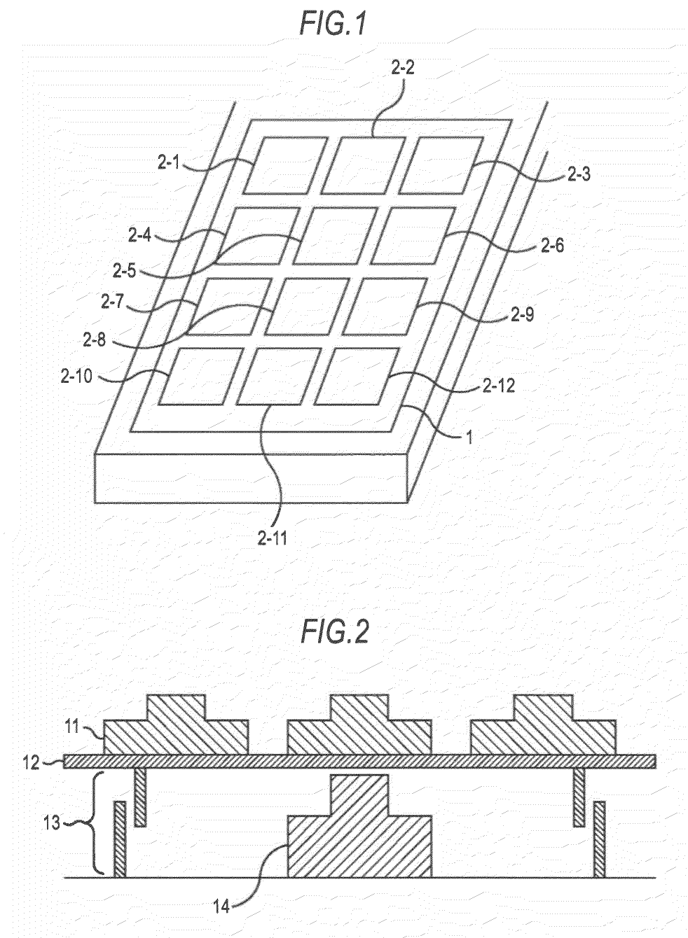

FIG. 1 shows an example of the external configuration of an input device according to an embodiment of the present invention.

As shown in FIG. 1, an input unit 1 of the input device includes keys 2-1 to 2-12 that are input mechanisms used for inputting corresponding information in accordance with a touch (contact) using a user's finger, a stylus pen that is operated by a user, or the like. As shown in FIG. 1, the keys 2-1 to 2-12 are disposed in a matrix shape and configure a so-called numeric keypad. The input unit 1 accepts a touch input for the keys 2-1 to 2-12 that is performed by a user's finger or the like. In addition, the input unit 1 accepts a slide input of touching any one of the keys 2-1 to 2-12 by using a user's finger or the like and then moving the contact portion in a predetermined direction to a key adjacent thereto with the contact maintained. Furthermore, the input unit 1 accepts a push input for the entire input unit 1 when any of the keys 2-1 to 2-12 is pushed (pressed down) by the user.

Hereinafter, in a case where the keys 2-1 to 2-12 of the input unit 1 do not need to be particularly identified, any one of the keys is referred to as a key 2.

As shown in FIG. 1, the key 2 is disposed to have a gap from an adjacent key 2. However, the keys 2 may be disposed without any gap interposed therebetween. In particular, in a case where the input unit 1 shown in FIG. 1 is applied to a software keyboard, the keys 2 are disposed without any gap interposed therebetween so as to accept a slide input between keys 2.

### [Hardware Configuration of Input Unit]

Next, the hardware configuration of the input unit 1 for a case where the input unit 1 is applied to a numeric keypad as a hardware keyboard will be described with reference to FIG. 2.

FIG. 2 is a side cross-sectional view of the input unit 1. As shown in FIG. 2, the input unit 1 is configured by a touch sensor 11, a base 12, a vertical-direction slider 13, and a push sensor 14.

The touch sensor 11 is disposed on the base 12 and corresponds to each key 2 shown in FIG. 1. The touch sensor 11 detects a user's touch (contact) on the key 2 and supplies a signal indicating a touch input for each key 2 to a CPU (Central Processing Unit), which is not shown in the figure, controlling the overall operation of the input device.

In addition, the touch sensor 11 detects a release (opening) at a time when, for example, a user's finger is separated from a key 2 from a state in which the user's finger touches the key 2 and supplies a signal indicating a release input for the key 2 to the CPU not shown in the figure.

Furthermore, when detecting a touch of a user's finger, for example, in the sequence of a touch on only a touch sensor 11 disposed on the right side, to a touch on two touch sensors 11 disposed on the right side and the center, and then to a touch on only the touch sensor 11 disposed on the center in FIG. 2, the touch sensors 11 detect a slide input from the touch sensor 11 disposed on the right side toward the touch sensor disposed on the center and supplies the information indicating a slide input to the CPU not shown in the figure.

The vertical-direction sliders 13 are disposed on the outer frame portion of the input unit 1. When one of the keys 2 corresponding to the touch sensor 11 is pushed (pressed down), the vertical-direction slider 13 is moved in the vertical direction (the downward direction in the figure) together with the base 12 while supporting the base 12. In addition, the vertical-direction slider 13 is configured to include a spring mechanism. When the user's finger is open after pushing (pressing down) the touch sensor 11, the vertical-direction slider 13 is moved to a position (the upward direction in the figure) before the push by the spring mechanism together with the base 12. As described above, the vertical-direction slider 13 represents the sense of click (sense of operation) of the input unit 1 by using the spring mechanism.

When the upper portion of the push sensor 14 is pressed by a lower face portion of the base 12 that is moved in the downward direction in the figure by pushing (pressing down) one of the touch sensors 11 corresponding to the key 2, the push sensor 14 supplies a signal indicating a push input to the CPU not shown in the figure.

In addition, as shown in FIG. 2, the touch sensor 11 corresponding to the key 2 is configured to be exposed. However, for example, the surface of the touch sensor 11 may be covered with resin having some degree of thickness for allowing the touch sensor 11 to function or the like.

Hereinafter, a concrete embodiment of an input device that includes an input unit having the above-described configuration will be described.

### 2. First Embodiment (Character Input in Mobile Terminal Device)

### [Configuration Example of Mobile Terminal Device]

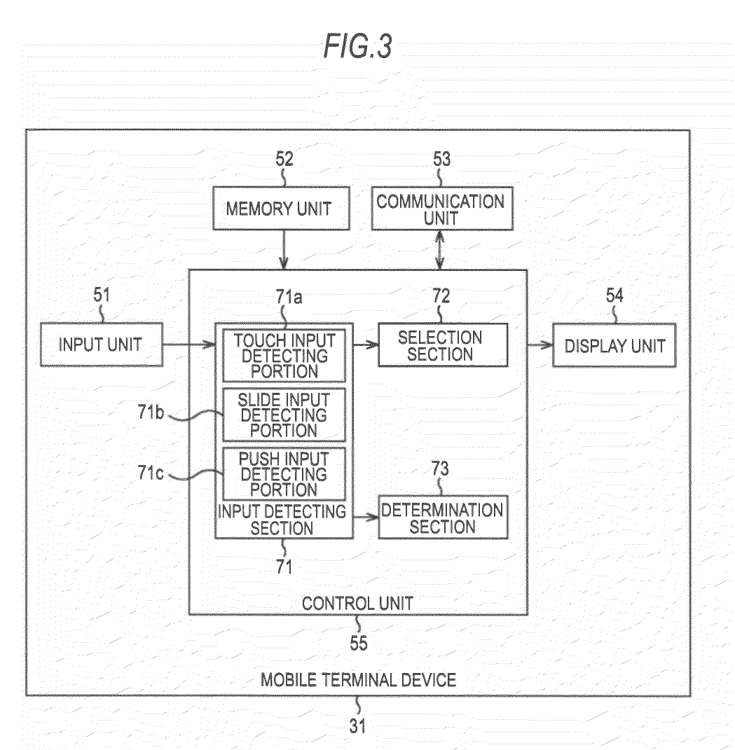

FIG. 3 shows a configuration example of a mobile terminal device as an input device according to an embodiment of the present invention.

The mobile terminal device 31 shown in FIG. 3, for example, is configured as a cellular phone, a PDA (Personal Digital Assistant), or the like. The mobile terminal device 31 is configured by an input unit 51, a memory unit 52, a communication unit 53, a display unit 54, and a control unit 55.

The input unit 51 is configured by various buttons including the above-described input unit 1 and the like. For example, the input unit 51 accepts an input according to a user's operation for various buttons and the like, in addition to accepting a touch input, a release input, a slide input, and a push input in accordance with a user's operation.

The memory unit 52 is configured by a hard disk drive, a semiconductor memory such as a memory card, or the like. For example, the memory unit 52 stores a program for controlling the overall operation of the mobile terminal device 31, dictionary data used for converting a character during character input, and the like therein.

The communication unit 53 performs data transmission and data reception with other devices through a wired network or a wireless network. For example, the communication unit 53 performs wired communication through a USB (Universal Serial Bus) cable or local radio communication by means of infrared rays or the like.

The display unit 54 is configured by a display device such as an LCD (Liquid Crystal Display) or an organic EL (Electro Luminescence). The display unit 54 displays a character or an image based on a control signal that is transmitted from the control unit 55 in accordance with a user's operation for the input unit 51.

The control unit 55 is configured to include the functions of the CPU, the touch sensor 11, and the push sensor 14 described above. The control unit 55 controls the overall operation of the mobile terminal device 31 based on the program stored in the memory unit 52. The control unit 55 is configured by an input detecting section 71, a selection section 72, and a determination section 73.

The input detecting section 71 detects an input for the input unit 51 and allows the control unit 55 to perform a corresponding process. In addition, the input detecting section 71 includes a touch input detecting portion 71a, a slide input detecting portion 71b, and a push input detecting portion 71c. The touch input detecting portion 71a, the slide input detecting portion 71b, and the push input detecting portion 71c detect a touch input, a release input, a slide input, and a push input of the input unit 51 and appropriately supply a corresponding detection signal to the selection section 72 or the determination section 73.

The selection section 72 selects predetermined information out of a plurality of types of information based on a detection signal transmitted from the input detecting section 71 and supplies a corresponding selection signal to the display unit 54.

The determination section 73 determines information selected by the selection section 72 in accordance with a detection signal transmitted from the input detecting section 71, determines (sets) the content of a process to be performed by the control unit 55, and supplies a corresponding determination signal to the display unit 54.

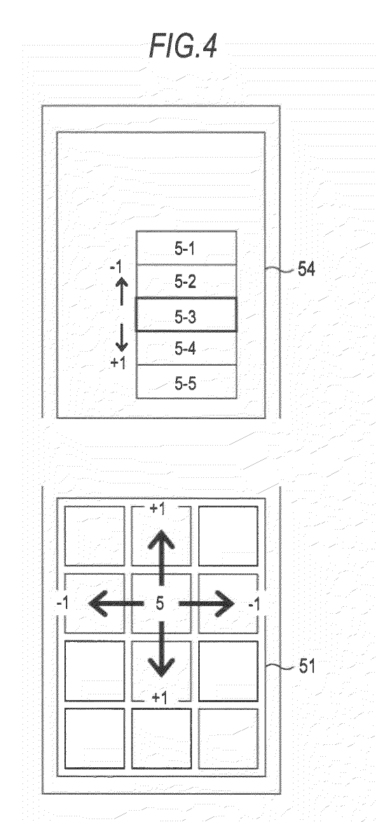

Here, the operation of selecting information in the mobile terminal device 31 will be described with reference to FIG. 4.

In FIG. 4, the mobile terminal device 31 as a cellular phone is shown. The input unit 51 is shown in the lower portion of FIG. 4, and the display unit 54 is shown in the upper portion of FIG. 4.

As shown in the lower portion of FIG. 4, in a case where a touch input for a key (a key corresponding to the key 2-5 shown in FIG. 1) on which a number “5” is indicated is performed by a user for the input unit 51, the touch input detecting portion 71a detects the touch input and supplies a corresponding detection signal to the selection section 72. The selection section 72 reads out information (hereinafter, referred to as accompanying information) relating to or accompanied by information corresponding to the key on which the number “5” is indicated from the memory unit 52 based on the detection signal transmitted from the touch input detecting portion 71a, temporarily stores the accompanying information, and supplies a display signal that is used for displaying the accompanying information read out from the memory unit 52 to the display unit 54. The display unit 54 displays a list of the accompanying information 5-1 to 5-5 as shown in the upper portion of FIG. 4 in accordance with the display signal transmitted from the selection section 72.

In a case where a slide input from the key, on which the number “5” is indicated, to a key (a key corresponding to the key 2-2 or 2-8 shown in FIG. 1) that is adjacent thereto in the vertical direction in the figure is performed for the input unit 51 by the user from the above-described state, the slide input detecting portion 71b detects the slide input performed in the vertical direction and supplies a corresponding detection signal to the selection section 72. The selection section 72 selects the accompanying information in accordance with the detection signal transmitted from the slide input detecting portion 71b such that a focus (the range of a frame attached to the accompanying information 5-3 in FIG. 4) is moved in the downward direction in the figure in the list (hereinafter, also referred to as selection items) displayed in the display unit 54. In other words, when a slide input between keys adjacent in the vertical direction (in the figure, the direction of an arrow denoted by “+1”) is detected for the keys of the input unit 51, the selection section 72 selects the accompanying information, which is temporarily stored, such that the focus is moved in the downward direction (in the figure, the direction of an arrow denoted by “+1”) in the selection items displayed on the display unit 54.

On the other hand, in a case where a slide input from the key, on which the number “5” is indicated, to a key (a key corresponding to the key 2-4 or 2-6 shown in FIG. 1) that is adjacent thereto in the horizontal direction in the figure is performed for the input unit 51 by the user, the slide input detecting portion 71b detects the slide input performed in the horizontal direction and supplies a corresponding detection signal to the selection section 72. The selection section 72 selects the accompanying information in accordance with the detection signal transmitted from the slide input detecting portion 71b such that the focus is moved in the upward direction in the figure in the selection items displayed in the display unit 54. In other words, when a slide input between keys adjacent to each other in the horizontal direction (in the figure, the direction of an arrow denoted by “−1”) is detected for the keys of the input unit 51, the selection section 72 selects the accompanying information, which is temporarily stored, such that the focus is moved in the upward direction (in the figure, the direction of an arrow denoted by “−1”) in the selection items displayed in the display unit 54.

As described above, the mobile terminal device 31 selects the accompanying information corresponding to the selection item displayed in the display unit 54 in accordance with the slide input between keys of the input unit 51.

### [Character Input Process of Mobile Terminal Device]

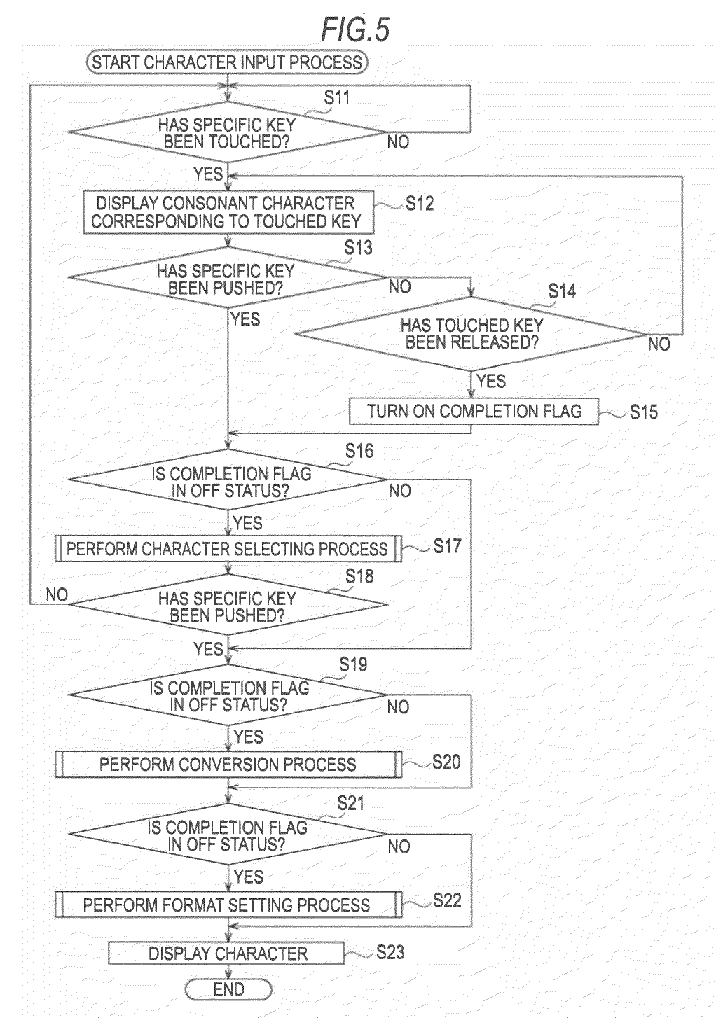

Next, a character input process performed by the mobile terminal device 31 will be described with reference to a flowchart shown in FIG. 5.

In Step S11, the touch input detecting portion 71a of the input detecting section 71 determines whether or not a specific key of the input unit 51 is touched.

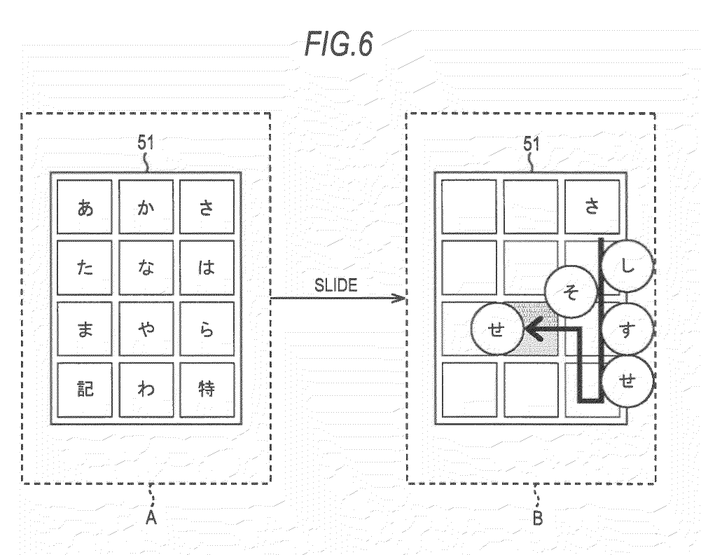

Here, the input unit 51 that is used for the character input process will be described with reference to FIG. 6.

As shown on the left side (state A) of FIG. 6, on the keys of the input unit 51, Japanese syllabary characters of [symbol] (a), [symbol] (ka), [symbol] (sa), [symbol] (ta), [symbol] (na), [symbol] (ha), [symbol] (ma), [symbol] (ya), [symbol] (ra), [symbol] (symbol), [symbol] (wa), and [symbol] (special character) are indicated in the order of the corresponding keys 2-1 to 2-12 shown in FIG. 1. In other words, the characters of each row in the Japanese syllabary as a group of characters are associated with the keys of the input unit 51. In more detail, for example, characters positioned in the row of [symbol] (a) in the Japanese syllabary, that is, ten characters of [symbol] (a), [symbol] (i), [symbol] (u), [symbol] (e), [symbol] (o), [symbol] (a), [symbol] (i), [symbol] (u), [symbol] (e) and [symbol] (o) are associated with a key corresponding to the key 2-1 shown in FIG. 1 on which the character of [symbol] (a) is indicated,. Similarly, for example, characters positioned in the row of [symbol] (sa) in the Japanese syllabary, that is, five characters of [symbol] (sa), [symbol] (shi), [symbol] (su), [symbol] (se) and [symbol] (so) are associated with a key corresponding to the key 2-3 shown in FIG. 1 on which the character of [symbol] (sa) is indicated,. In addition, [symbol] (symbol) indicated in a key corresponding to the key 2-11 shown in FIG. 1 represents a symbol. Thus, “,” (comma), “.” (period), “•” (centered dot), “!” (exclamation mark), “?” (question mark), and the like are associated with this key. Furthermore, [symbol] (special characters) indicated in a key corresponding to the key 2-13 shown in FIG. 1 represents “special characters”. Thus, “”” (voiced sound mark), “° ” (half-voiced sound mark), “-” (macron), “ ” (space), and the like are associated with this key.

In a case where any key among the keys displayed in state A shown in FIG. 6 is determined not to have been touched in Step S11, the process is repeated until a touch input for a specific key is detected by the touch input detecting portion 71a.

On the other hand, in Step S11, in a case where a specific key among the keys displayed in state A shown in FIG. 6 is determined to have been touched, that is, when a touch input is detected by the touch input detecting portion 71a, the touch input detecting portion 71a supplies a corresponding detection signal to the selection section 72. The selection section 72 reads out the accompanying information (character) for information (a consonant row) corresponding to the touched key from the memory unit 52 in accordance with the detection signal transmitted from the touch input detecting portion 71a and temporarily stores the accompanying information, and then the process proceeds to Step S12.

In Step S12, the display unit 54 displays a consonant character corresponding to the touched key. In more detail, the selection section 72 supplies a display signal used for displaying the information corresponding to the touched key out of the accompanying information read out from the memory unit 52 to the display unit 54, and the display unit 54 displays a consonant character corresponding to the touched key in accordance with the display signal transmitted from the selection section 72. For example, in a case where a key, on which the character of [symbol] (sa) is indicated, among the keys of the input unit 51 is touched in state A shown in FIG. 6, the display unit 54 displays a first character of the row of [symbol] (sa) in the Japanese syllabary.

In Step S13, the push input detecting portion 71c determines whether or not a specific key (for example, the key touched in Step S11) is pushed in the input unit 51.

In a case where a specific key is determined not to have been pushed in Step S13, the process proceeds to Step S14, and the touch input detecting portion 71a determines whether or not the touched key has been released.

In a case where the touched key is determined to have been released in Step S14, the touch input detecting portion 71a detects the release input and supplies a corresponding detection signal to the determination section 73, and the process proceeds to Step S15.

In Step S15, the control unit 55 turns on a completion flag in accordance with the detection of the release input by using the touch input detecting portion 71a, and the process proceeds to Step S16.

Here, the completion flag is a flag that is set in a memory area, which is not shown in the figure, inside the control unit 55. When the completion flag is turned on, the mobile terminal device 31 skips a predetermined process during the character input process, and the character input process is completed. The completion flag is turned off when the character input process is started.

On the other hand, in a case where a specific key is determined to have been pushed in Step S13, the push input detecting portion 71c detects the push input and supplies a corresponding detection signal to the determination section 73, and the process proceeds to Step S16.

In Step S16, the control unit 55 determines whether or not the completion flag is in the OFF status in accordance with supply of a predetermined detection signal to the determination section 73.

In a case where the completion flag is determined to be in the OFF status in Step S16, the process proceeds to Step S17. Then, the mobile terminal device 31 performs a character selecting process in which a character positioned in the consonant row corresponding to the touched key is selected.

### [Character Selecting Process of Mobile Terminal Device]

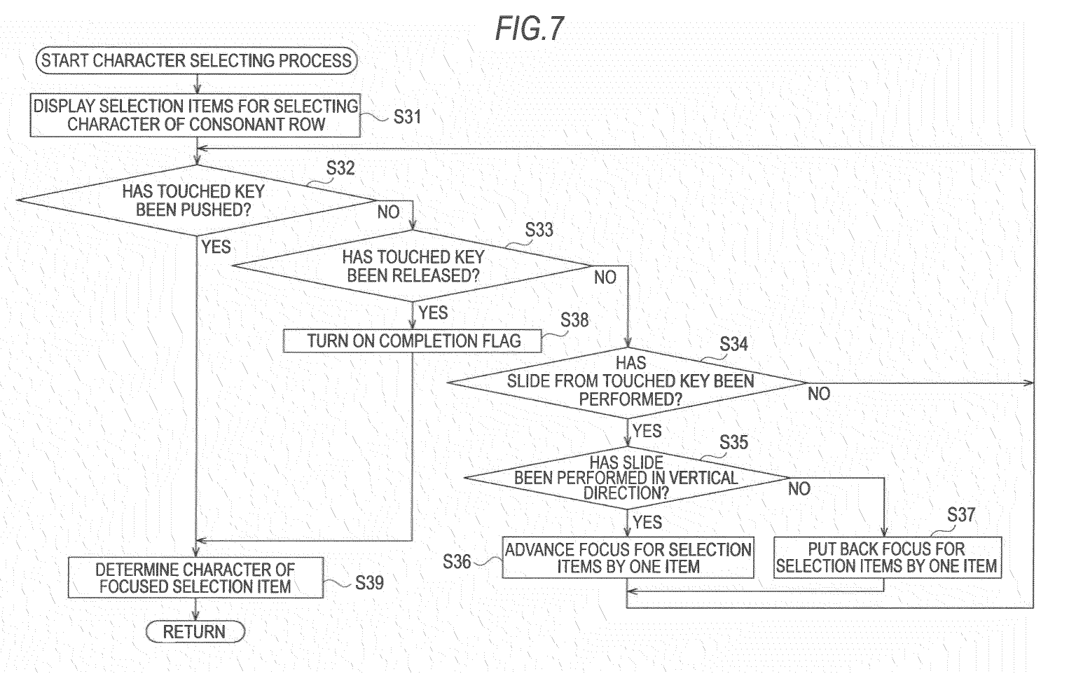

Here, the character selecting process performed by the mobile terminal device 31 will be described with reference to a flowchart shown in FIG. 7.

In Step S31, the display unit 54 displays selection items used for selecting a character of the consonant row corresponding to the touched key. In more detail, the selection section 72 supplies a display signal used for displaying the accompanying information read out from the memory unit 52 to the display unit 54, and the display unit 54 displays selection items for selecting a character of the consonant row corresponding to the touched key based on the display signal transmitted from the selection section 72.

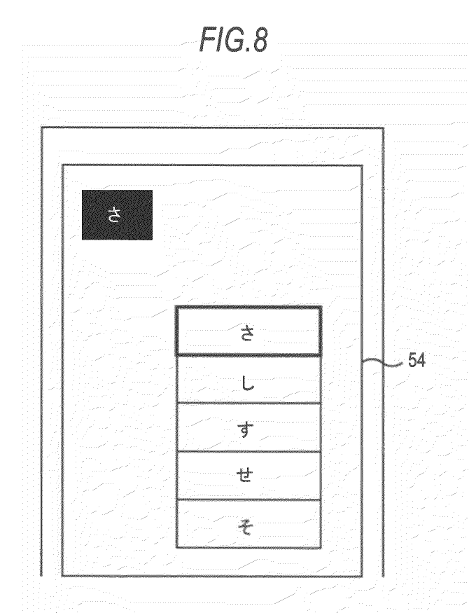

For example, in a case where a key, on which the character [symbol] (sa) is indicated, out of the keys of the input unit 51 is touched and pushed in state A shown in FIG. 6, as shown in FIG. 8, the display unit 54 displays selection items for selecting a character from the row of [symbol] (sa) including [symbol] (sa), [symbol] (shi), [symbol] (su), [symbol] (se) and [symbol] (so). In the selection items displayed in the display unit 54 shown in FIG. 8, five characters of [symbol] (sa), [symbol] (shi), [symbol] (su), [symbol] (se) and [symbol] (so) are sequentially displayed from the upper side. Right after the selection items are displayed, the selection item [symbol] (sa) is focused, and on the upper left side of the display unit 54, the first character [symbol] (sa) positioned in the row of [symbol] (sa) in the Japanese syllabary is displayed with being inverted in black and white in accordance with the process of Step S12.

In Step S32, the push input detecting portion 71c determines whether or not the touched key is pushed in the input unit 51.

In a case where the touched key is determined not to have been pushed in Step S32, the process proceeds to Step S33. Then, the touch input detecting portion 71a determines whether or not the touched key has been released in the input unit 51.

In Step S33, in a case where the touched key is determined not to have been released, that is, when the key pushed in Step S13 of the flowchart shown in FIG. 5 remains in the touched state, the process proceeds to Step S34.

In Step S34, the slide input detecting portion 71b determines whether or not a slide is performed from the touched key.

In a case where a slide is determined to have been performed from the touched key in Step S34, that is, when a slide input is detected by the slide input detecting portion 71b, the slide input detecting portion 71b supplies a corresponding detection signal to the selection section 72, and the process proceeds to Step S35. For example, in a case where a key on which a character [symbol] (sa) is indicated is touched in the state A shown in FIG. 6, there is no key adjacent thereto in the upward direction or the rightward direction, and accordingly, it is determined whether a slide is performed in the downward direction or the leftward direction.

In Step S35, the selection section 72 determines whether or not a slide is performed in the vertical direction from the touched key based on the detection signal transmitted from the slide input detecting portion 71b. In more detail, slide direction information indicating whether a slide is performed in the vertical direction from the touched key or a slide is performed in the horizontal direction from the touched key is included in the detection signal transmitted from the slide input detecting portion 71b. Thus, the selection section 72 determines whether or not a slide is performed from the touched key in the vertical direction based on the slide direction information.

In a case where a slide is determined to have been performed in the vertical direction from the touched key in Step S35, the process proceeds to Step S36.

In Step S36, the display unit 54 advances the focus for the selection items by one item. In more detail, the selection section 72 selects a character positioned in the row corresponding to the key that is touched first so as to advance the focus for the selection items of the display unit 54 by one item. For example, in the display unit 54 shown in FIG. 8, the selection section 72 selects [symbol] (shi) that is the second character positioned in the row of [symbol] (sa) in the Japanese syllabary so as to move the focus in the downward direction by one item from the selection item [symbol] (sa). Thereafter, the process is returned back to Step S32.

On the other hand, in Step S35, in a case where a slide is determined not to have been performed in the vertical direction from the touched key, that is, when a slide is performed in the horizontal direction from the touched key, the process proceeds to Step S37.

In Step S37, the display unit 54 puts the focus back for the selection items by one item. In more detail, the selection section 72 selects a character positioned in the row corresponding to the key touched first so as to put the focus back for the selection items of the display unit 54 by one item. For example, for the display unit 54 shown in FIG. 8, the selection section 72 selects [symbol] (so) that is the fifth character positioned in the row of [symbol] (sa) in the Japanese syllabary so as to move the focus in the upward direction (in this case, a bottommost selection item) by one item from the selection item [symbol] (sa). Thereafter, the process is returned to Step S32.

In other words, in the process of Steps S32 to S37, each time a slide is detected without any push or release, the focus is moved to the upper side or the lower side in the selection items of the display unit 54 in accordance with the slide direction.

On the other hand, in a case where the touched key is determined to have been released in Step S33, the touch input detecting portion 71a detects the release input and supplies a corresponding detection signal to the determination section 73. Then, the process proceeds to Step S38.

In Step S38, the control unit 55 turns on the completion flag in accordance with the detection of the release input that is detected by the touch input detecting portion 71a, and the process proceeds to Step S39.

In addition, in a case where the touched key is determined to have been pushed in Step S32, the push input detecting portion 71c detects the push input and supplies a corresponding detection signal to the determination section 73, and the process proceeds to Step S39.

In Step S39, the determination section 73 determines the character (Japanese syllabary character) that is focused in the display unit 54 when the key is pushed in Step S32 or released in Step S33 as an input character based on the detection signal transmitted from the touch input detecting portion 71a or the push input detecting portion 71c and supplies a corresponding determination signal to the display unit 54. At this time, for example, in the display unit 54, one character determined in Step S39 is displayed in the upper left position of the display unit 54 shown in FIG. 8, and input of a next character (second character) positioned to the right side of the character is in the standby state.

For example, in a case where a key on which a character [symbol] (sa) is indicated is touched from state A shown in FIG. 6, and as shown in the right side (state B) of FIG. 6, and a slide is performed in the downward direction by three items, in the upward direction by one item, and in the leftward direction by one item, the character corresponding to the selection item to which the focus is moved in the display unit 54 is shifted to [symbol] (shi), [symbol] (su), [symbol] (se), [symbol] (so) and [symbol] (se). At this time, the key that is finally touched is a key (in the figure, a shaded key) corresponding to the key 2-8 shown in FIG. 1. Thus, when the key is pushed or released, in the display unit 54 (a portion in which a character [symbol] (sa) is displayed in the display unit shown in FIG. 6), a character [symbol] (se) is displayed, and input of the second character is in the standby state.

According to the above-described processes, the mobile terminal device 31 displays the selection items used for selecting a specific character from a group of characters assigned to a touched key and can select a character corresponding to the selection item displayed in the display unit 54 in accordance with only a slide input between keys of the input unit 51 disposed in the vertical direction or the horizontal direction.

Referring back to the flowchart shown in FIG. 5, after the character selecting process of Step S17, the push input detecting portion 71c determines whether or not a specific key is pushed in the input unit 51 in Step S18.

In a case where any key is determined not to have been pushed in Step S18, the process is returned back to Step S11, and the process thereafter is repeated. In other words, an input of a second character and a character thereafter can be accepted.

On the other hand, in a case where a specific key is determined to have been pushed in Step S18, the push input detecting portion 71c detects the push input and supplies a corresponding detection signal to the selection section 72 and the determination section 73. The determination section 73 sets the character (character line) selected and determined in the process of Steps S11 to S17 as an input character (input character line) based on the detection signal transmitted from the push input detecting portion 71c, and the process proceeds to Step S19.

In addition, in a case where the completion flag is determined not to be in the OFF status in Step S16, that is, when the completion flag is turned on in Step S15 or Step S17 performed at the second time or thereafter, Steps S17 and S18 are skipped, and the process proceeds to Step S19.

In Step S19, the control unit 55 determines whether the completion flag is in the OFF state based on detection of a detection signal in the determination section 73 in Step S18.

In a case where the completion flag is determined to be in the OFF status in Step S19, the process proceeds to Step S20, and the mobile terminal device 31 performs a conversion process for converting the set input character (input character line).

### [Conversion Process of Mobile Terminal Device]

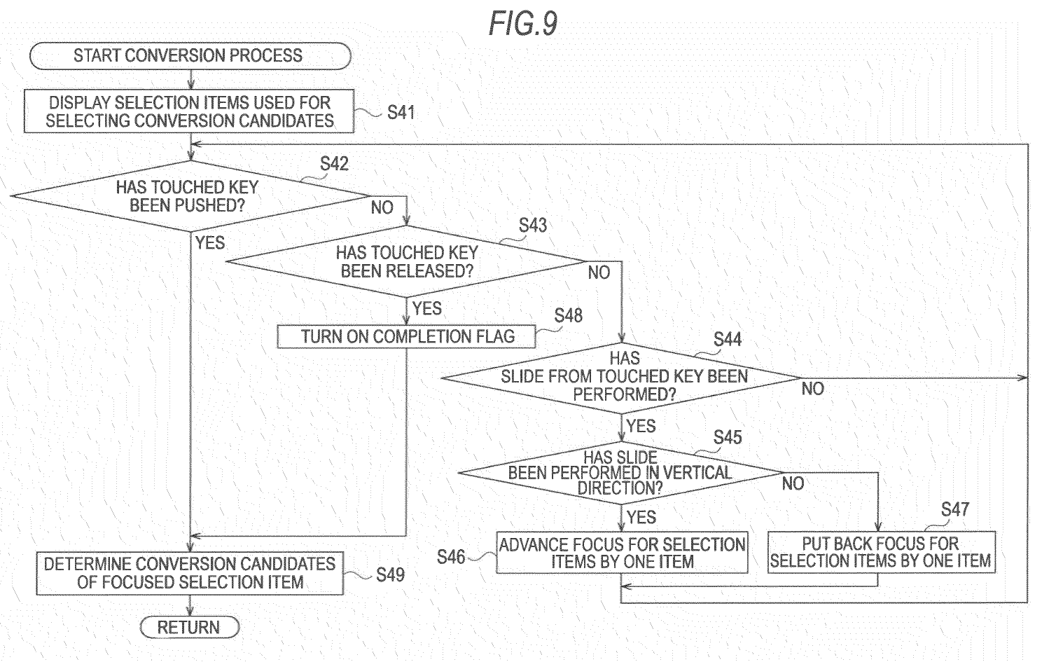

Here, a conversion process performed by the mobile terminal device 31 will be described with reference to a flowchart shown in FIG. 9.

In Step S41, the display unit 54 displays selection items used for selecting conversion candidates of the input character (input character line) set in Step S18. In more detail, the selection section 72 reads out conversion candidates of the set input character from the memory unit 52 in accordance with the detection signal that is transmitted from the push input detecting portion 71c and is supplied in Step S18 and supplies a display signal used for displaying the conversion candidates to the display unit 54. The display unit 54 displays the selection items used for selecting the conversion candidates of the input character based on the display signal transmitted from the selection section 72.

For example, in a case where [symbol] (seki) is set as the input character line in Step S18, as shown in FIG. 10, the display unit 54 displays selection items for selecting one from conversion candidates of a Kanji character [symbol] (seki), a Kanji character [symbol] (seki), a Kanji character [symbol] (seki), a Kanji character [symbol] (seki), and a Kanji character [symbol] (seki). As the selection items in the display unit 54 shown in FIG. 10, five conversion candidates of the Kanji character [symbol] (seki), the Kanji character [symbol] (seki), the Kanji character [symbol] (seki), the Kanji character [symbol] (seki), and the Kanji character [symbol] (seki) are sequentially displayed from the upper side. Immediately after the selection items are displayed, the selection item of the Kanji character [symbol] (seki) is focused.

In Step S42, the push input detecting portion 71c determines whether or not the touched key is pushed in the input unit 51.

In Step S42, in a case where the touched key is determined not to have been pushed, the process proceeds to Step S43, and the touch input detecting portion 71a determines whether or not the touched key is in the input unit 51.

In Step S43, in a case where the touched key is determined not to have been released, that is, when the key pushed in Step S18 of the flowchart shown in FIG. 5 remains in the touched state, the process proceeds to Step S44.

In Step S44, the slide input detecting portion 71b determines whether or not a slide is performed from the touched key.

In Step S44, in a case where a slide is determined to have been performed from the touched key, that is, when a slide input is detected by the slide input detecting portion 71b, the slide input detecting portion 71b supplies a corresponding detection signal to the selection section 72, and the process proceeds to Step S45.

In Step S45, the selection section 72 determines whether or not a slide is performed in the vertical direction from the touched key based on the detection signal transmitted from the slide input detecting portion 71b. In more detail, the selection section 72 determines whether or not a slide is performed in the vertical direction from the touched key based on the slide direction information included in the detection signal.

In a case where a slide is determined to have been performed in the vertical direction from the touched key in Step S45, the process proceeds to Step S46.

In Step S46, the display unit 54 advances the focus for the selection items by one item. In more detail, the selection section 72 selects a conversion candidate for the input character line from the selection items of the display unit 54 so as to advance the focus by one item. For example, in the display unit 54 shown in FIG. 10, the selection section 72 selects the Kanji character [symbol] (seki), which is the second conversion candidate, so as to move the focus from the selection item of the Kanji character [symbol] (seki) to the downward direction by one item. Thereafter, the process is returned back to Step S42.

On the other hand, in Step S45, in a case where a slide is determined not to have been performed in the vertical direction from the touched key, that is, when a slide is performed in the horizontal direction from the touched key, the process proceeds to Step S47.

In Step S47, the display unit 54 puts the focus back for the selection items by one item. In more detail, the selection section 72 selects a selection candidate for the input character line so as to put the focus back for the selection items of the display unit 54 by one item. For example, for the display unit 54 shown in FIG. 10, the selection section 72, selects a conversion candidate for [symbol] (seki) so as to move the focus in the upward direction (in this case, a selection item after the selection item of the Kanji character [symbol] (seki), which is not shown in the figure) by one item from the selection item of the Kanji character [symbol] (seki). Thereafter, the process is returned back to Step S42.

In other words, in the process of Steps S42 to S47, each time a slide is detected without any push or release, the focus is moved to the upper side or the lower side in the selection items of the display unit 54 in accordance with the slide direction.

On the other hand, in a case where the touched key is determined to have been released in Step S43, the touch input detecting portion 71a detects the release input and supplies a corresponding detection signal to the determination section 73. Then, the process proceeds to Step S48.

In Step S48, the control unit 55 turns on the completion flag in accordance with the detection of the release input that is detected by the touch input detecting portion 71a, and the process proceeds to Step S49.

In addition, in Step S42, in a case where the touched key is determined to have been pushed, that is, when a push input is detected by the push input detecting portion 71c, the push input detecting portion 71c supplies a corresponding detection signal to the determination section 73, and the process proceeds to Step S49.

In Step S49, the determination section 73 determines a conversion candidate for the selection item focused in the display unit 54 at a time when the key is pushed in Step S42 or released in Step S43 based on the detection signal transmitted from the touch input detecting portion 71a or the push input detecting portion 71c and supplies a corresponding determination signal to the display unit 54.

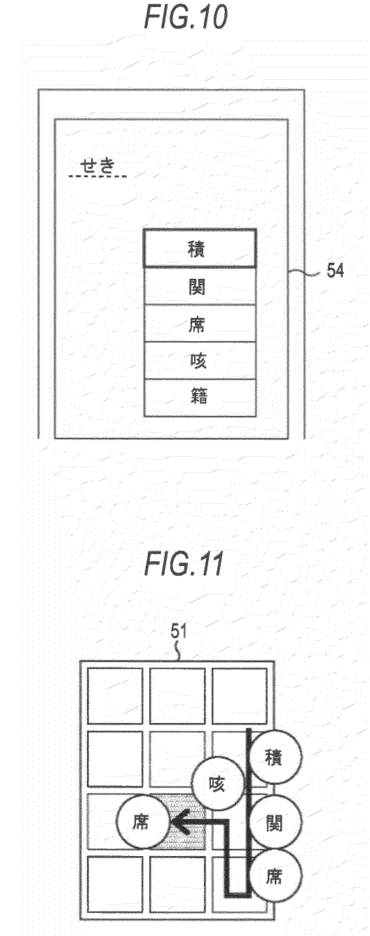

For example, after Step S18, in a case where a key corresponding to the key 2-3 shown in FIG. 1 is touched, and a slide is performed in the downward direction by three items, in the upward direction by one item, and in the leftward direction by one item, the conversion candidate corresponding to the selection item to which the focus is moved in the display unit 54 is shifted, as shown in FIG. 11, to the Kanji character [symbol] (seki), the Kanji character [symbol] (seki), the Kanji character [symbol] (seki), the Kanji character [symbol] (seki), and the Kanji character [symbol] (seki). At this time, the key that is finally touched is a key (in the figure, a shaded key) corresponding to the key 2-8 shown in FIG. 1. Thus, when the key is pushed or released, the Kanji character [symbol] (seki) is displayed in the display unit 54.

According to the above-described processes, the mobile terminal device 31 displays the selection items used for selecting a conversion candidate during character input and can select a conversion candidate corresponding to the selection item displayed in the display unit 54 in accordance with only a slide input between keys of the input unit 51 disposed in the vertical direction or the horizontal direction.

Referring back to the flowchart shown in FIG. 5, after the conversion process of Step S20, the process proceeds to Step S21.

In addition, in a case where the completion flag is determined not to be in the OFF state in Step S19, that is, when the completion flag is turned on in Step S15 or Step S17, Step S20 is skipped, and the process proceeds to Step S21.

In Step S21, the control unit 55 determines whether the completion flag is in the OFF state based on detection of a predetermined detection signal in the determination section 73 in Step S20.

In a case where the completion flag is determined to be in the OFF state in Step S21, the process proceeds to Step S21, and the mobile terminal device 31 performs a format setting process for setting the format of the converted character.

### [Format Setting Process of Mobile Terminal Device]

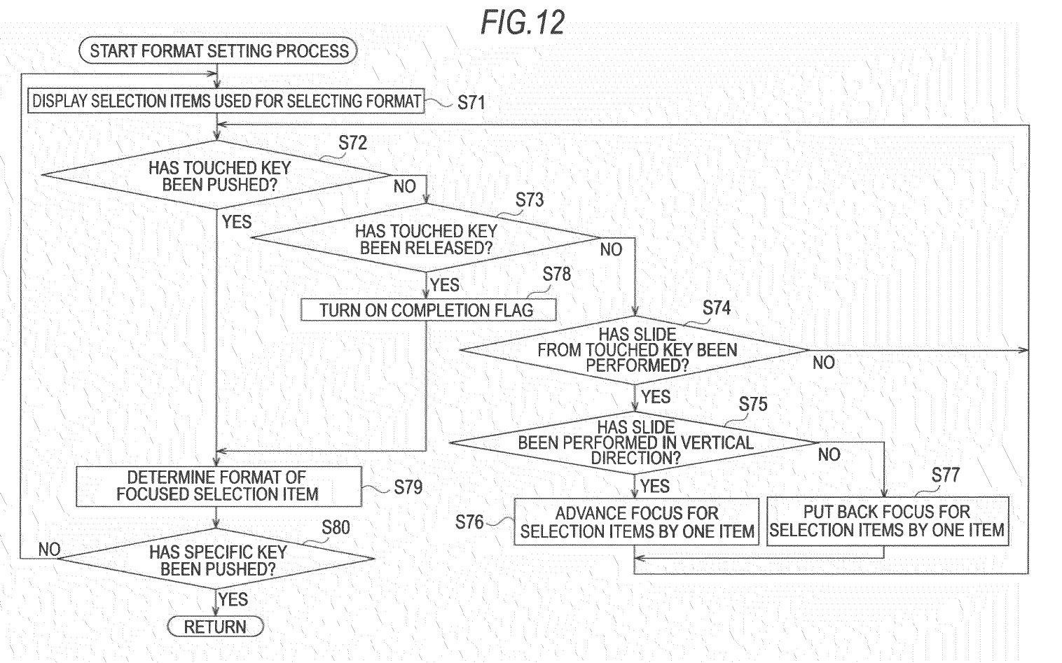

Here, a format setting process performed by the mobile terminal device 31 will be described with reference to a flowchart shown in FIG. 12.

In Step S71, the display unit 54 displays selection items used for selecting (setting) the format of the input character converted in Step S20. In more detail, the selection section 72 reads out setting information used for setting the character size from the memory unit 52 and supplies a display signal used for displaying the setting information to the display unit 54. Then, the display unit 54 displays selection items used for selecting the format of the input character based on the display signal transmitted from the selection section 72.

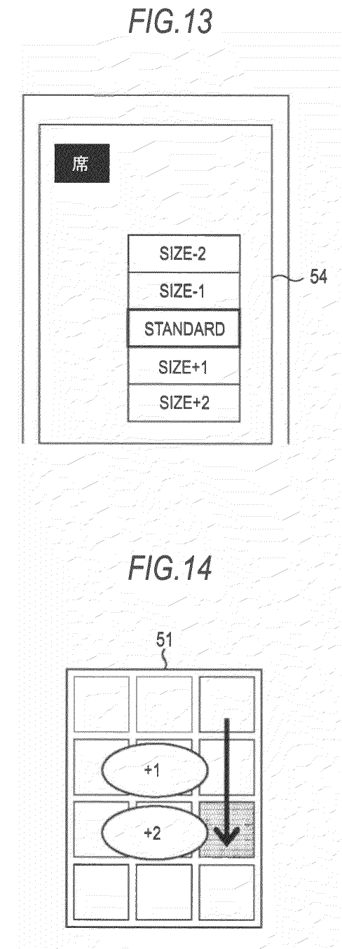

For example, in a case where the Kanji character [symbol] (seki) is set in Step S20, as shown in FIG. 13, the display unit 54 displays selection items used for selecting “Size−2”, “Size−1”, “Standard”, “Size+1”, and “Size+2” that are used for setting the character size. In the selection items displayed in the display unit 54 shown in FIG. 13, five size levels of “Size−2”, “Size−1”, “Standard”, “Size+1”, and “Size+2” are sequentially displayed from the upper side. Right after the selection items are displayed, the selection item “Standard” is focused.

In Step S72, the push input detecting portion 71c determines whether or not the touched key is pushed in the input unit 51.

In a case where the touched key is determined not to have been pushed In Step S72, the process proceeds to Step S73, and the touch input detecting portion 71a determines whether or not the touched key is released in the input unit 51.

In Step S73, in a case where the touched key is determined not to have been released, that is, when the key pushed in Step S20 of the flowchart shown in FIG. 5 remains in the touched state, the process proceeds to Step S74.

In Step S74, the slide input detecting portion 71b determines whether or not a slide is performed from the touched key.

In Step S74, in a case where a slide is determined to have been performed from the touched key, that is, when a slide input is detected by the slide input detecting portion 71b, the slide input detecting portion 71b supplies a corresponding detection signal to the selection section 72, and the process proceeds to Step S75.

In Step S75, the selection section 72 determines whether or not a slide is performed in the vertical direction from the touched key based on the detection signal transmitted from the slide input detecting portion 71b. In more detail, the selection section 72 determines whether or not a slide is performed in the vertical direction from the touched key based on the slide direction information that is included in the detection signal.

In a case where a slide is determined to have been performed in the vertical direction from the touched key in Step S75, the process proceeds to Step S76.

In Step S76, the display unit 54 advances the focus for the selection items by one item. In more detail, the selection section 72 selects a conversion candidate for the input character line for the selection items of the display unit 54 so as to advance the focus by one item. For example, in the display unit 54 shown in FIG. 13, the selection section 72 selects the size level “Size+1” so as to move the focus by one item in the downward direction from the selection item “Standard”. Thereafter, the process is returned to Step S72.

On the other hand, in Step S75, in a case where a slide is determined not to have been performed in the vertical direction from the touched key, that is, when a slide is performed in the horizontal direction from the touched key, the process proceeds to Step S77.

In Step S77, the display unit 54 puts the focus back for the selection items by one item. In more detail, the selection section 72 selects a selection candidate for the input character line so as to put the focus back for the selection items of the display unit 54 by one item. For example, for the display unit 54 shown in FIG. 13, the selection section 72, for example, selects the size level “Size−1” so as to move the focus in the upward direction by one item from the selection item “Standard”. Thereafter, the process is returned to Step S72.

In other words, in the process of Steps S72 to S77, each time a slide is detected without any push or release, the focus is moved to the upper side or the lower side in the selection items of the display unit 54 in accordance with the slide direction.

On the other hand, in a case where the touched key is determined to have been released in Step S73, the touch input detecting portion 71a detects the release input and supplies a corresponding detection signal to the determination section 73. Then, the process proceeds to Step S78.

In Step S78, the control unit 55 turns on the completion flag in accordance with the detection of the release input that is detected by the touch input detecting portion 71a, and the process proceeds to Step S79.

In addition, in Step S72, in a case where the touched key is determined to have been pushed in Step 72, that is, when a push input is detected by the push input detecting portion 71c, the push input detecting portion 71c supplies a corresponding detection signal to the determination section 73, and the process proceeds to Step S79.

In Step S79, the determination section 73 determines the size level of a character of a selection item that is focused in the display unit 54 at a time when the key is pushed in Step S72 or released in Step S43 as a format based on the detection signal transmitted from the touch input detecting portion 71a or the push input detecting portion 71c and supplies a corresponding determination signal to the display unit 54.

For example, after Step S20, in a case where a key corresponding to the key 2-3 shown in FIG. 1 is touched and is slid in the downward direction by two items, the size level corresponding to the selection item to which focus is shifted in the display unit 54, as shown in FIG. 14, is shifted to “Size+1” and “Size+2”. At this time, the key that is finally touched is a key (in the figure, a shaded key) corresponding to the key 2-9 shown in FIG. 1. Thus, when the key is pushed or released, a Kanji character [symbol] , which represents a seat, having the size level of “Size+2” is displayed in the display unit 54.

In Step S80, the push input detecting portion 71c determines whether or not a specific key is pushed in the input unit 51.

In a case where any key is determined not to have been pushed in Step S80, the process is returned back to Step S71.

In Step S71 performed for the second time, the display unit 54 displays selection items used for selecting (setting) the color of the character of which the size has been set in Step S79 performed for the first time. In more detail, for example, the selection section 72 reads out setting information used for setting the color of the character from the memory unit 52 and supplies a display signal used for displaying the setting information to the display unit 54. The display unit 54 displays the selection items used for selecting the color of the input character based on the display signal transmitted from the selection section 72.

Thereafter, similarly to the process of the first time, when the color of the character is set in the second process, in Step S71 performed for the third time, selection items used for selecting whether to set the boldface of the character are displayed. Then, in Step S71 performed for the fourth time, selection items used for selecting whether to use the underline of the character are displayed. Then, in Step S71 performed for the fifth time, selection items used for selecting whether to set the italic face of the character are displayed. In Step S71 performed thereafter, the selection items used for selecting the character size are displayed again. Thereafter, the process of setting the color of the character, setting the bold face, setting whether to set the underline, setting an Italic face, and setting the font is repeated through the process of Steps S71 to Step S80 until a specific key is pushed in Step S80.

In addition, in a case where a specific key is determined to have been pushed in Step S80, the push input detecting portion 71c detects the push input and supplies a corresponding detection signal to the determination section 73. The determination section 73 sets the format of the character that is selected and determined (set) in the process of Steps S71 to S79 based on the detection signal transmitted from the push input detecting portion 71c, and the process is returned back to Step S22 of the flowchart shown in FIG. 5.

According to the above-described processes, the mobile terminal device 31 displays the selection items used for selecting (setting) the format of an input character and can select the format corresponding to the selection item displayed in the display unit 54 in accordance with only a slide input between keys of the input unit 51 disposed in the vertical direction or the horizontal direction.

Referring back to the flowchart shown in FIG. 5, after the format setting process of Step S22, the process proceeds to Step S23.

In addition, in a case where the completion flag is determined not to be in the OFF state in Step S21, that is, when the completion flag is turned on in Step S15, Step S17, or Step S20, Step S22 is skipped, and the process proceeds to Step S23.

In Step S23, the determination section 73 supplies the display signal used for displaying the character which has been converted and of which the format is set through the above-described process to the display unit 54, and the display unit 54 displays the character based on the display signal.

According to the above-described process, the mobile terminal device 31 displays selection items used for selecting the accompanying information of character input, and the accompanying information corresponding to the selection item displayed in the display unit 54 can be selected in accordance with only a slide input between keys of the input unit 51 disposed in the vertical direction or the horizontal direction.

The configuration of the above-described input unit 51 may be applied to either a hardware keyboard or a software keyboard. In the numeric keypad as the above-described input unit 51, even each corner key has a key located adjacent thereto. Accordingly, in a case where the input unit 51 is implemented by a software keyboard, corner keys do not need to accept a slide input in an area other than an area in which the keyboard is displayed. Therefore, an area does not need to be disposed for a slide in the periphery of the area in which the keyboard is displayed, whereby the input unit can be configured within a relatively small area. On the other hand, in a case where the input unit 51 is implemented by a hardware keyboard, each key does not need to detect the direction of a slide. Accordingly, each key does not need to have sensors for each direction, whereby the input unit can be configured to have a relatively simple structure. In other words, an input unit that occupies a small area and has a simple structure can be configured.

In addition, a user can perform a continuous operation through a slide input. Accordingly, the burden on a user's finger can be decreased, whereby the input speed can be raised. Furthermore, a push input may not be needed for selection, and accordingly, an error in the selection made by mistakenly pressing down an adjacent key can be decreased.

In addition, in the above-described processes, the Japanese syllabary characters are configured to be assigned to the keys of the input unit 51. However, for example, similarly to a general cellular phone, the Latin alphabet may be assigned to the keys.

As presented above, a case where the present invention is applied to a mobile terminal device in which characters are input has been described. However, the present invention can be applied to a remote controller used for selecting contents (programs) in a television set.

### 3. Second Embodiment (Contents Selection in Television Set)

### [Configuration Example of Remote Controller and Television Set]

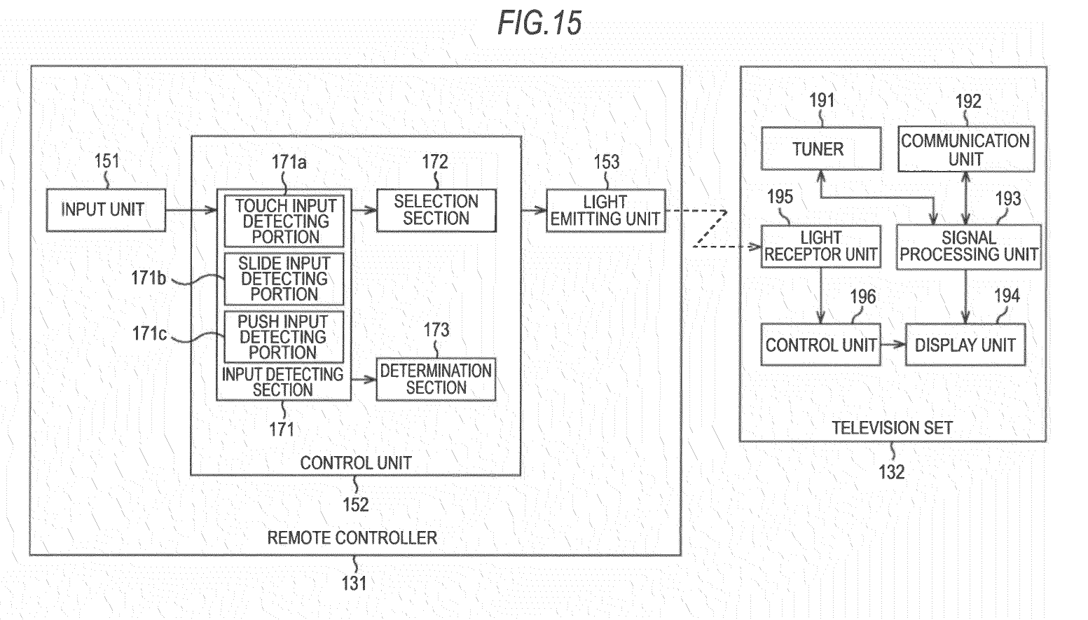

FIG. 15 shows a configuration example of a remote controller as an input device according to an embodiment of the present invention and a corresponding television set according to another embodiment of the present invention.

As shown in FIG. 15, a remote controller 131 supplies a command for a process (operation) corresponding to a user's operation to a television set 132. In more detail, for example, the remote controller 131 is operated by a user and transmits a command corresponding to the operation to the television set 132. The television set 132 displays a content (program) corresponding to the user's operation based on the command transmitted from the remote controller 131.

The remote controller 131 is configured by an input unit 151, a control unit 152, and a light emitting unit 153.

In the remote controller 131 shown in FIG. 15, the input unit 151, the control unit 152, and an input detecting section 171, a selection section 172, and a determination section 173 that are included in the control unit 152 have basically the same functions as those of the input unit 51 and the control unit 55 of the mobile terminal device 31 shown in FIG. 3 and the input detecting section 71, the selection section 72, and the determination section 73 that are included in the control unit 55. Thus the description thereof is appropriately omitted. This also applies to a touch input detecting portion 171a, a slide input detecting portion 171b, and a push input detecting portion 171c that are disposed in the input detecting section 171.

The light emitting unit 153 transmits (supplies) a control signal, which is transmitted from the control unit 152, corresponding to the user's operation for the input unit 151 to the television set by means of infrared rays.

The television set 132 is configured by a tuner 191, a communication unit 192, a signal processing unit 193, a display unit 194, a light receptor unit 195, and a control unit 196.

The tuner 191 receives a broadcast signal that is a broadcast wave transmitted from a broadcast station not shown in the figure, demodulates the broadcast signal, and supplies image data and audio data of a content (program) acquired by demodulating the broadcast signal to the signal processing unit 193. The broadcast wave received by the tuner 191 may be a terrestrial wave of a digital signal or a satellite wave of a digital signal that is irradiated through a satellite.

The communication unit 192 transmits and receives various types of data through a network such as the Internet not shown in the figure. For example, the communication unit 192 acquires program related information that is information relating to a program acquired by the tuner 191 through the network from a server not shown in the figure and supplies the program related information to the signal processing unit 193.

The signal processing unit 193 decodes the image data and the audio data transmitted from the tuner 191 by using a predetermined method such as an MPEG (Moving Picture Experts Group) 2 and performs a predetermined process such as a predetermined data type converting process or a D/A (Digital-to-Analog) conversion process for encoded data. The signal processing unit 193 supplies an audio signal to an audio signal output unit not shown in the figure together with supplying an image signal acquired as a result of the predetermined process to the display unit 194.

In addition, the signal processing unit 193 supplies a display signal, which is used for displaying various types of data transmitted from the communication unit 192, to the display unit 194.

The display unit 194 displays an image corresponding to the image signal transmitted from the signal processing unit 193.

The light receptor unit 195 receives a control signal that is transmitted from the light emitting unit 153 of the remote controller 131 by means of infrared rays, performs photoelectric conversion for the control signal, and supplies the converted control signal to the control unit 196.

The control unit 196 is configured by a built-in type microcomputer that is configured by a CPU, a ROM (Read Only Memory), a RAM (Random Access Memory), and the like. The control unit 196 controls the overall operation of the television set 132 based on a program that is stored in the ROM. In addition, the control unit 196 performs various processes, which may be needed, in accordance with a control signal that is supplied from the light receptor unit 195.

### [Program Selecting Process of Remote Controller]

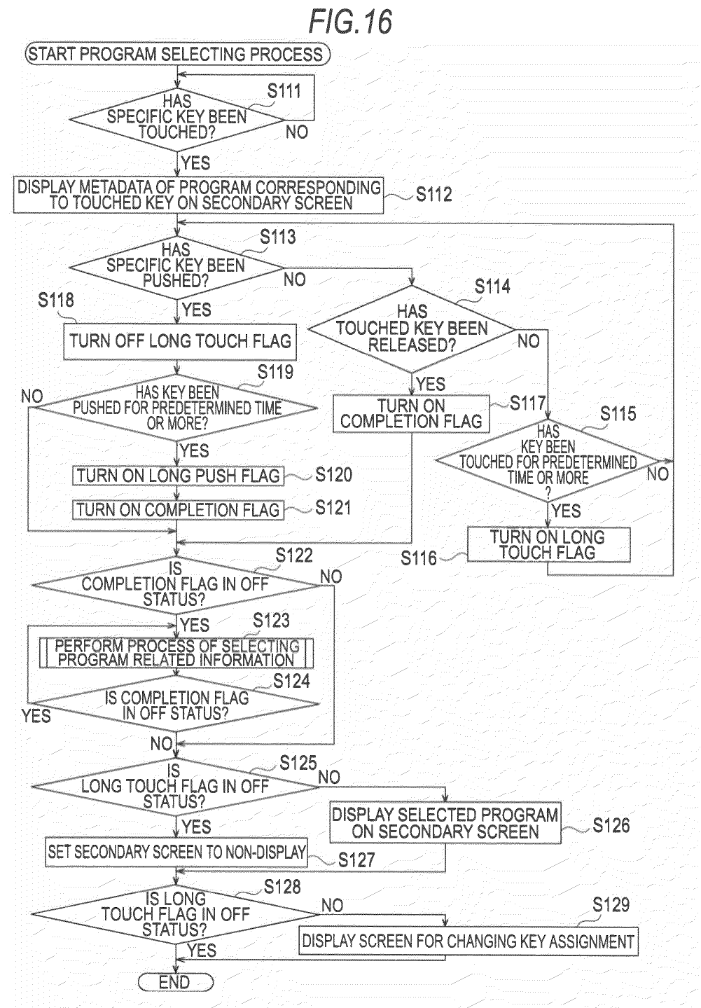

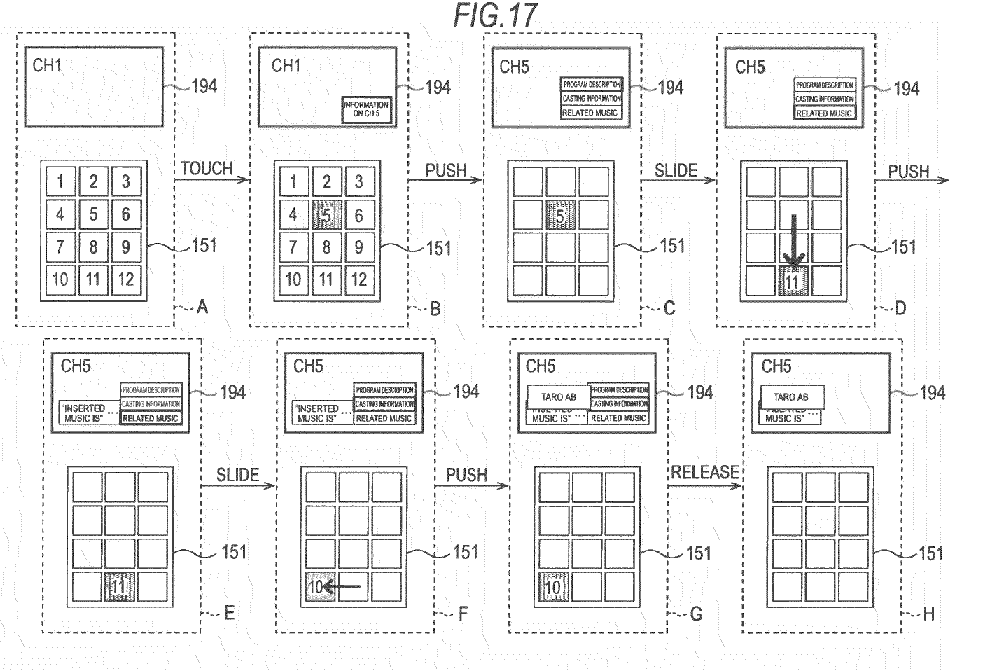

Next, a program selecting process in the television set 132, which is performed by the remote controller 131, will be described with reference to the flowchart shown in FIG. 16.

In Step S111, the touch input detecting portion 171a of the input detecting section 171 determines whether or not a specific key is touched in the input unit 151.

Here, the input unit 151 of the remote controller 131 and the display unit 194 of the television set 132 in the program selecting process will be described with reference to FIG. 17.

As shown on the leftmost side (state A) of the upper end of FIG. 17, numbers “1”, “2”, “3”, “4”, “5”, “6”, “7”, “8”, “9”, “10”, “11” and “12” are indicated on the keys of the input unit 151 in the order of corresponding keys 2-1 to 2-12 shown in FIG. 1. In addition, programs of channel 1 (ch 1) to channel 12 (ch 12) are assigned to the keys of the input unit 151. In state A shown in FIG. 17, a program of channel 1 is displayed in the display unit 194. The program of such a channel is acquired by the tuner 191, a predetermined process is performed for the program by the signal processing unit 193, and the processed program is supplied as an image signal to the display unit 194. However, the program (content) displayed in the display unit 194 may be acquired by the communication unit 192 through a network such as the Internet.

In Step S111, in a case where any key among the keys shown in state A of FIG. 17 is determined not to have been touched, the process is repeated until a touch input for a specific key is detected by the touch input detecting portion 171a.

On the other hand, if a specific key among the keys shown in state A of FIG. 17 is determined to have been touched in Step S111, that is, when a touch input is detected by the touch input detecting portion 171a, the touch input detecting portion 171a supplies a corresponding detection signal to the determination section 173. The determination section 173 allows the light emitting unit 153 to transmit a signal indicating the touch on the specific key to the television set 132 by means of infrared rays.

In Step S112, the display unit 194 of the television set 132 displays metadata of a program corresponding to the touched key of the input unit 151 of the remote controller 131 on a secondary screen. In more detail, the control unit 196 allows the display unit 194 to display metadata of a program corresponding to the touched key on a secondary screen based on the signal that is transmitted from the remote controller 131 by means of infrared rays and is received by the light receptor unit 195.

For example, in state A shown in FIG. 17, in a case where a key on which the number “5” is indicated is touched among the keys of the input unit 151, as shown in state B shown in FIG. 17, the display unit 194 displays metadata (for example, a thumbnail image, a program name, broadcast start time, broadcast end time, and the like) of a program broadcasted through channel 5 on the secondary screen. In addition, the metadata is assumed to be acquired, for example, by the tuner 191 together with the broadcast signal.

In Step S113, the push input detecting portion 171c of the input detecting section 171 determines whether or not a specific key (for example, the key touched in Step S111) is pushed in the input unit 151.

In a case where a specific key is determined not to have been pushed in Step S113, the process proceeds to Step S114. Then, the touch input detecting portion 171a determines whether or not the touched key is released.

In a case where the touched key is determined not to have been released in Step S114, the process proceeds to Step S115. Then, the touch input detecting portion 171a determines whether or not the touched key is touched for a predetermined time or more.

In a case where the touched key is determined not to have been touched for the predetermined time or more in Step S115, the process is returned back to Step S112.

On the other hand, in Step S115, if the touched key is determined to have been touched for the predetermined time or more, that is, when a touch input is detected by the touch input detecting portion 171a even when the predetermined time has elapsed after the key is touched in Step S111, the touch input detecting portion 171a supplies a corresponding detection signal to the determination section 173. The determination section 173 allows the light emitting unit 153 to transmit a signal indicating the touch for the predetermined time or more to the television set 132 by means of infrared rays, and the process proceeds to Step S116.

In Step S116, the control unit 196 of the television set 132 turns on a long touch flag in accordance with the signal that is transmitted from the remote controller 131 by means of infrared rays and is received by the light receptor unit 195. Then, the process is returned back to Step S112.

Here, the long touch flag is a flag that is set in a memory area, not shown in the figure, inside the control unit 196 of the television set 132. The television set 132 controls display of the secondary screen of the display unit 194 in accordance with the status of the long touch flag. The long touch flag is turned off when the program selecting process is started.

On the other hand, if the touched key is determined to have been released in Step S114, the touch input detecting portion 171a detects the release input and supplies a corresponding detection signal to the determination section 73. The determination unit 173 allows the light emitting unit 153 to transmit a signal indicating the release to the television set 132 by means of infrared rays. Then, the process proceeds to Step S117.

In Step S117, the control unit 196 of the television set 132 turns on the completion flag in accordance with the signal that is transmitted from the remote controller 131 by means of infrared rays and is received by the light receptor unit 195. Then, the process proceeds to Step S122.

Here, the completion flag is a flag that is set in a memory area, not shown in the figure, inside the control unit 196 of the television set 132. When the completion flag is turned on, the television set 132 skips a predetermined process in the program selecting process and completes the program selecting process. The completion flag is turned off when the program selecting process is started.

In addition, in Step S113, in a case where a specific key is determined to have been pushed, that is, when a push input is detected by the push input detecting portion 171c, the push input detecting portion 171c supplies a corresponding detecting signal to the determination section 173. The determination section 173 allows the light emitting unit 153 to transmit a signal indicating the push to the television set 132 by means of infrared rays. Then, the process proceeds to Step S118.

In Step S118, the control unit 196 of the television set 132 turns off the long touch flag in accordance with the signal that is transmitted from the remote controller 131 by means of infrared rays and is received by the light receptor unit 195. The process of Step S118 is performed in a case where the long touch flag is turned on in Step S116.

In Step S119, the push input detecting portion 171c determines whether or not the pushed key has been pushed for a predetermined time or more.

In Step S119, in a case where the pushed key is determined to have been pushed for the predetermined time or more, that is, when a push input is detected by the push input detecting portion 171c even when the predetermined time has elapsed after the push in Step S113, the push input detecting portion 171c supplies a corresponding detection signal to the determination section 173. The determination section 173 allows the light emitting unit 153 to transmit a signal indicating the push for the predetermined time or more to the television set 132 by means of infrared rays, and the process proceeds to Step S120.

In Step S120, the control unit 196 of the television set 132 turns on a long push flag in accordance with the signal that is transmitted from the remote controller 131 by means of infrared rays and is received by the light receptor unit 195.

Here, the long push flag is a flag that is set in a memory area, not shown in the figure, inside the control unit 196 of the television set 132. The television set 132 controls display of the display unit 194 in accordance with the status of the long push flag. The long push flag is turned off when the program selecting process is started.

In Step S121, the control unit 196 of the television set 132 turns on the completion flag in accordance with the signal that is transmitted from the remote controller 131 by means of infrared rays and is received by the light receptor unit 195.

On the other hand, in Step S119, if the pushed key is determined not to have been pushed for the predetermined time or more, that is, when a push input is not detected by the push input detecting portion 171c before the predetermined time elapses after the push in Step S113, the process of Steps S120 and S121 is skipped.

In Step S122, the control unit 196 of the television set 132 determines whether the completion flag is in the OFF status.

In a case where the completion flag is determined to be in the OFF status in Step S122, the process proceeds to Step S123, and the remote controller 131 and the television set 132 perform a program related-information selecting process of selecting program related information of a program corresponding to the touched key.

### [Program-Related Information Selecting Process of Remote Controller]

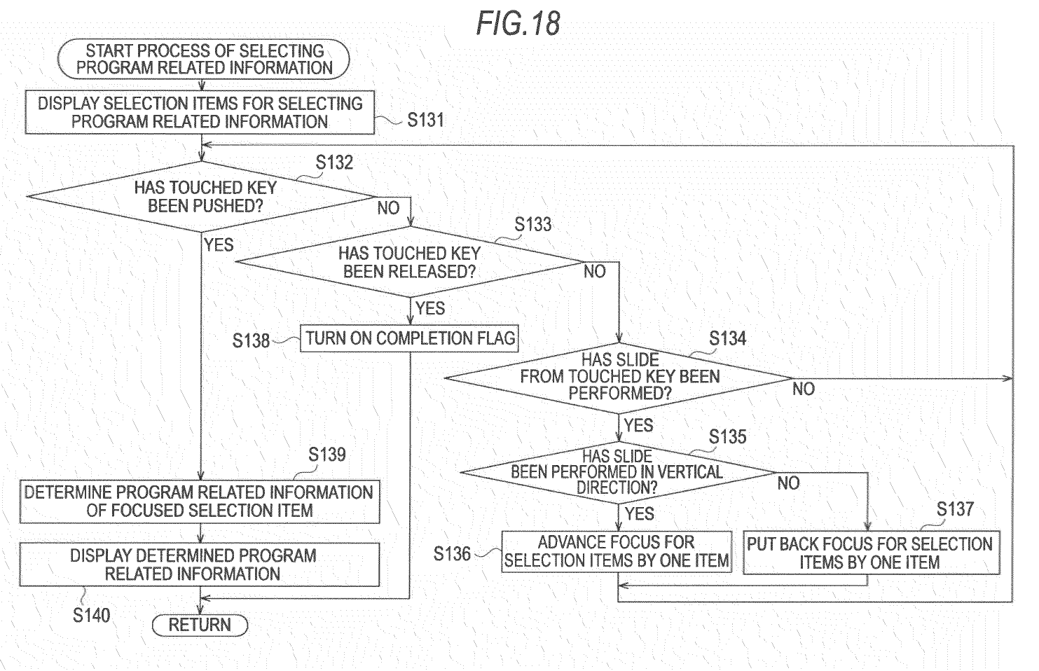

Here, the program-related information selecting process performed by the remote controller 131 will be described with reference to a flowchart shown in FIG. 18.

In Step S131, the display unit 194 of the television set 132 displays selection items used for selecting the program related information of the program of which metadata is displayed on the secondary screen. In more detail, the control unit 196 allows the display unit 194 to display selection items used for selecting the program related information of the program of which metadata is displayed on the secondary screen in accordance with a signal that is transmitted from the remote controller 131 by means of infrared rays and is received by the light receptor unit 195. In addition, at this moment, the control unit 196 displays the program of which the metadata is displayed on the secondary screen in full screen of the display unit 194.

For example, in state B shown in FIG. 17, in a case where a specific key (for example, a key on which a number “5” is indicated) among the keys of the input unit 151 is pushed (Step S113), as shown in state C of FIG. 17, the display unit 194 displays the program of channel 5 in full screen and displays the program related information of the program.

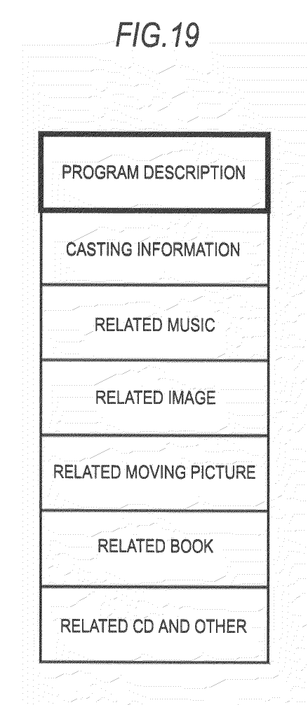

Here, the program related information displayed in the display unit 194 will be described in detail with reference to FIG. 19.

As shown in FIG. 19, as the selection items displayed in the display unit 194, seven items of “program description”, “casting information”, “related music”, “related image”, “related moving picture”, “related book”, and “related CD and other” are sequentially displayed from the upper side. Right after the selection items are displayed in the display unit 194, the selection item of “program description” is focused.

In addition, the content of the program related information that is displayed in the display unit 194 described later is acquired by the communication unit 192, for example, from a predetermined server through a network such as the Internet in correspondence with a program acquired by the tuner 191.

For example, in the program related information as “program description”, a program title, an overview, cast member's names, director/producer, a total broadcast time, an elapse time, the degree of recommendation, external link information, and the like are included. In the program related information as “casting information”, cast members' names, profiles of cast members, comments from cast members, images (including moving pictures) of cast members, and the like are included. In the program related information as “related music”, a music title, artist names, composer/lyricist names, a production company name, comments on the music, and the like that are relating to the program are included. In the program related information as “related image”, images relating to the program, comments on the images, and the like are included. In the program related information as “related moving picture”, moving pictures' (contents') titles relating to the program, thumbnail images, cast members' names, a director's name, a producing company name, and the like are included. In addition, in the program related information as “related book”, a book title, thumbnail images, an author's name, a publisher's name, and the like that are relating to the program are included. In the program related information as “related CD and other”, titles of a CD (Compact Disc) and a DVD (Digital Versatile Disc), thumbnail images, cast member's names, a director's name, a release company name, and the like that are relating to the program are included.

In Step S132, the push input detecting portion 171c determines whether or not the touched key is pushed in the input unit 151.

In Step S132, in a case where the touched key is determined not to have been pushed, the process proceeds to Step S133, and the touch input detecting portion 171a determines whether or not the touched key is released in the input unit 151.

In Step S133, in a case where the touched key is determined not to have been released, that is, when the key pushed in Step S113 of the flowchart shown in FIG. 16 remains in the touched state, the process proceeds to Step S134.

In Step S134, the slide input detecting portion 171b determines whether or not a slide is performed from the touched key.

In Step S134, in a case where a slide is determined to have been performed from the touched key, that is, when a slide input is detected by the slide input detecting portion 171b, the slide input detecting portion 171b supplies a corresponding detection signal to the selection section 172, and the process proceeds to Step S135. For example, as state C of FIG. 17, in a case where, after a key on which a number “5” is indicated is pushed, a slide is performed in any of the vertical or horizontal direction from the touched state, the process proceeds to Step S135.

In Step S135, the selection section 172 determines whether or not a slide is performed in the vertical direction from the touched key based on the detection signal transmitted from the slide input detecting portion 171b. In more detail, slide direction information indicating whether a slide is performed in the vertical direction or the horizontal direction from the touched key is included in the detection signal transmitted from the slide input detecting portion 171b. Thus, the selection section 172 determines whether or not a slide is performed in the vertical direction from the touched key based on the slide direction information.

In a case where a slide is determined to have been performed in the vertical direction from the touched key in Step S135, the process proceeds to Step S136.

In Step S136, the display unit 194 of the television set 132 advances the focus for the selection items by one item. In more detail, the selection section 172 allows the light emitting unit 153 to transmit a signal indicating selection of the program related information of the program displayed in full screen to the television set 132 by means of infrared rays so as to advance the focus for the selection items of the display unit 194 by one item. The control unit 196 of the television set 132 allows the focus for the selection items of the program related information of the program displayed in the display unit 194 to advance by one item based on the signal that is transmitted from the remote controller 131 by means of infrared rays and is received by the light receptor unit 195. Then, the process is returned back to Step S132.

On the other hand, in Step S135, if a slide is determined not to have been performed in the vertical direction from the touched key, that is, when a slide is performed in the horizontal direction from the touched key, the process proceeds to Step S137.

In Step S137, the display unit 194 puts the focus for the selection items back by one item. In more detail, the selection section 172 allows the light emitting unit 153 to transmit a signal indicating selection of the program related information of the program displayed in full screen to the television set 132 by means of infrared rays so as to put the focus for the selection items of the display unit 194 back by one item. The control unit 196 of the television set 132 puts the focus for the selection items of the program related information of the program displayed in the display unit 194 back by one item based on the signal that is transmitted from the remote controller 131 by means of infrared rays and is received by the light receptor unit 195. Then, the process is returned back to Step S132.

In other words, in the process of Steps S132 to S137, each time a slide is detected without any push or release, the focus is moved to the upper side or the lower side in the selection items of the display unit 194 in accordance with the slide direction.

On the other hand, if the touched key is determined to have been released in Step S133, the touch input detecting portion 71a detects the release input and supplies a corresponding detection signal to the determination section 173. Then, the determination section 173 allows the light emitting unit 153 to transmit a signal indicating the release to the television set 132 by means of infrared rays, and the process proceeds to Step S138.

In Step S138, the control unit 196 of the television set 132 turns on the completion flag based on the signal that is transmitted from the remote controller 131 by means of infrared rays and is received by the light receptor unit 195. Then, the process is returned back to Step S123 of the flowchart shown in FIG. 16.

In addition, in Step S132, in a case where the touched key is determined to have been pushed, that is, when a push input is detected by the push input detecting portion 171c, the push input detecting portion 171c supplies a corresponding detection signal to the determination section 173. The determination section 173 allows the light emitting unit 153 to transmit a corresponding signal to the television set 132 by means of infrared rays based on the detection signal transmitted from the push input detecting portion 171c. Then, the process proceeds to Step S139.

In Step S139, the control unit 196 of the television set 132 determines the program related information of the selection item focused in the display unit 194 based on the signal that is transmitted from the remote controller 131 by means of infrared rays and is received by the light receptor unit 195 and supplies a corresponding determination signal to the display unit 194.

In Step S140, the display unit 194 displays the determined program related information based on the determination signal transmitted from the control unit 196. Then, the process is returned back to Step S123 of the flowchart shown in FIG. 16.

For example, in a case where a slide for two items is performed in the downward direction as shown in state D shown in FIG. 17 from state C shown in FIG. 17 that is a state in which the key on which the number “5” is indicated is touched, the program related information corresponding to the selection item to which the focus is moved in the display unit 194 becomes “related music” that is positioned third from the top in the selection items shown in FIG. 19. At this time, the touched key is a key on which a number “11” is indicated. Thus, when the key is pushed, as shown in state E of FIG. 17, “inserted music is . . . ” is displayed in the lower left portion of the display unit 194 as the information on the related music.

As described above, the remote controller 131 can select the program related information corresponding to the selection item used for selecting the program related information as the accompanying information on the program displayed in the display unit 194 of the television set 132 based on only the slide input between keys of the input unit 151 that are disposed in the vertical direction or the horizontal direction.

Referring back to the flowchart shown in FIG. 16, the control unit 196 determines whether or not the completion flag is in the OFF status in Step S124.

In Step S124, in a case where the completion flag is determined to be in the OFF status, that is, the completion flag is not turned on in the program related information selecting process of Step S123, the process is returned back to Step S123. Then, the program related information selecting process is repeated until the completion flag is turned on (Step S138).

For example, in a case where any key (for example, a key on which a number “11” is indicated) is not released from the state shown in state E of FIG. 17, the selection items of the program related information are maintained to be displayed in the display unit 194. At this time, as shown in state E of FIG. 17, the selection item of “related music”, which was selected at the previous time, among the selection items of the program related information is focused. In this state, as shown in state F of FIG. 17, when a slide for two items is performed in the leftward direction for the input unit 151, the program related information corresponding to the selection item to which the focus is moved in the display unit 194 becomes “casting information” positioned second from the top in the selection items shown in FIG. 19, which is acquired by putting the focus back by one item from “related music” positioned third from the top in the selection items. At this time, the touched key is a key on which a number “10” is indicated. Thus, when the key is pushed, as shown in state G of FIG. 17, information of “TARO AB” is displayed on the lower left portion of the display unit 194 as the casting information, in addition to the information on the related music of “the inserted music is . . . ”.

In addition, in a case where the completion flag is determined not to be in the OFF state in Step S122 or Step S124, that is, when the completion flag is turned on in Step S117, Step S121, or Step S123, the display unit 194 completes display when the selection items of the program related information are displayed. Then, the process proceeds to Step S125.

For example, in a case where the key on which the number “10” is indicated is released from the state shown in state G of FIG. 17, as shown in state H of FIG. 17, the selection items of the program related information disappear in the display unit 194. Then, the information on the related music of “inserted music is and information of “TARO AB” as the casting information are displayed together with the program broadcasted through channel 5.

In Step S125, the control unit 196 determines whether or not the long touch flag is in the OFF status.

In Step S125, in a case where the long touch flag is determined not to be in the OFF status, that is, when the long touch flag is in the ON status, the process proceeds to Step S126.

In Step S126, the control unit 196 determines display of a program of a channel assigned to the key selected (touched) in Step S111 on the secondary screen and displays the program of the selected channel on the secondary screen of the display unit 194.

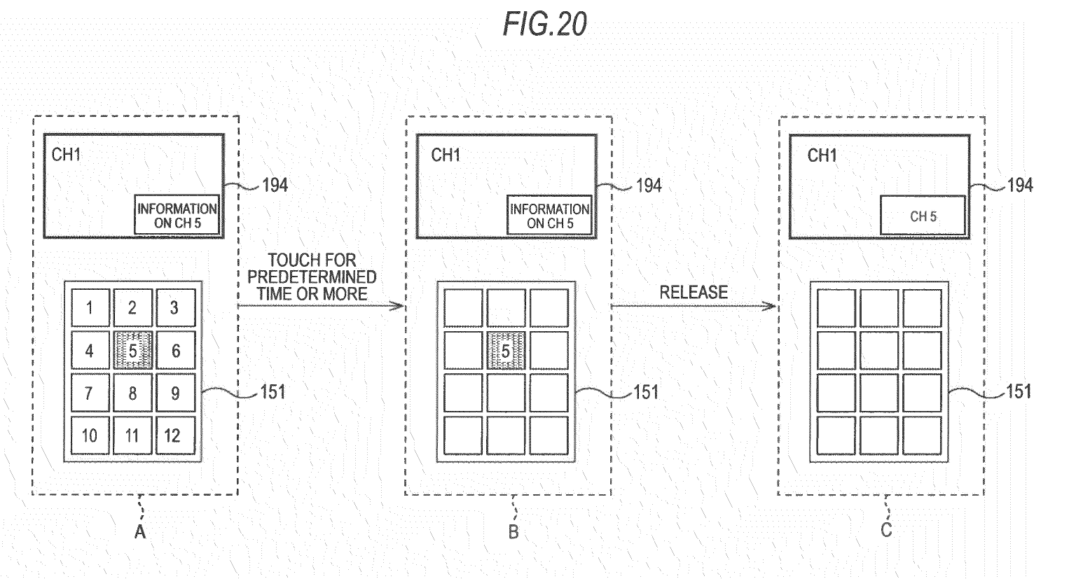

For example, as shown in state A of FIG. 20 that is the same state as state B of FIG. 17, from the state in which a key on which a number “5” is indicated is touched (Step S111), when the key is touched for a predetermined time or more (Step S115) and then released (Step S114), as shown in state B of FIG. 20, the program of channel 5, of which metadata is displayed, is displayed on the secondary screen of the display unit 194 as shown in state C of FIG. 20.

As described above, the television set 132 can display the program of the channel selected in accordance with the touch input for the input unit 151 of the remote controller 131 on the secondary screen of the display unit 194 by performing a touch input for the input unit 151 for a predetermined time or more. Accordingly, the user can watch a desired program by performing a relatively small number of operations.

On the other hand, if the long touch flag is determined to be in the OFF state in Step S125, the process proceeds to Step S127, and the control unit 196 sets the secondary screen displayed in the display unit 194 to non-display. In a case where the program related information selecting process of Step S123 is performed, the secondary screen of the display unit 194 is already in the non-display state, and accordingly, the process of Step S125 is not performed.

In Step S128, the control unit 196 determines whether or not the long push flag is in the OFF status.

In Step S128, in a case where the long push flag is determined not to be in the OFF status, that is, in a case where the long push flag is in the ON status, the process proceeds to Step S129.

In Step S129, the control unit 196 allows the display unit 194 to display a key assignment changing screen for checking whether or not the channel of the program, of which metadata is displayed on the secondary screen, is assigned to the key pushed for the predetermined time or more, and the process is completed.

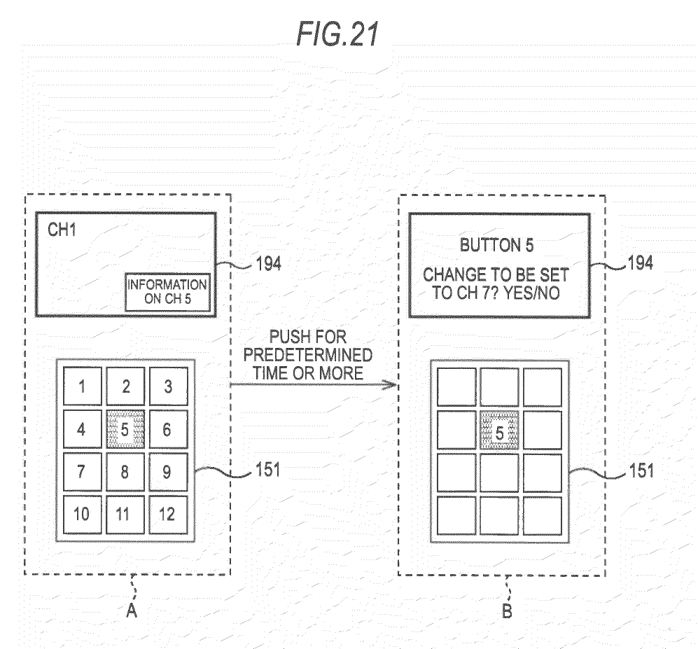

For example, as shown in state A of FIG. 21 that is the same state as state B of FIG. 17, from the state in which the key on which the number “5” is indicated is touched (Step S111), as shown in state B of FIG. 21, when the key is pushed for the predetermined time or more (Step S119), as a message for checking whether the channel of the program of which metadata is displayed on the secondary screen is assigned to the pushed key, “Is button 5 changed to be set to ch 7? YES/NO” is displayed in the display unit 194.

As described above, the television set 132 can assign the channel selected in accordance with a touch input for the input unit 151 of the remote controller 131 to a so-called long-pushed key of the input unit 151. Accordingly, for example, a user can conveniently customize the remote controller by assigning channels to the keys of the remote controller in the order of his or her taste or the like.

On the other hand, if the long push flag is determined to be in the OFF status in Step S128, the process is completed.

As shown in FIG. 17, the display unit 194 displays a plurality of the types of the program related information by repeatedly selecting the program related information of the program that is displayed in full screen. However, by configuring the program related information to have a hierarchical structure, the display unit 194 maybe configured to display more detailed program related information.

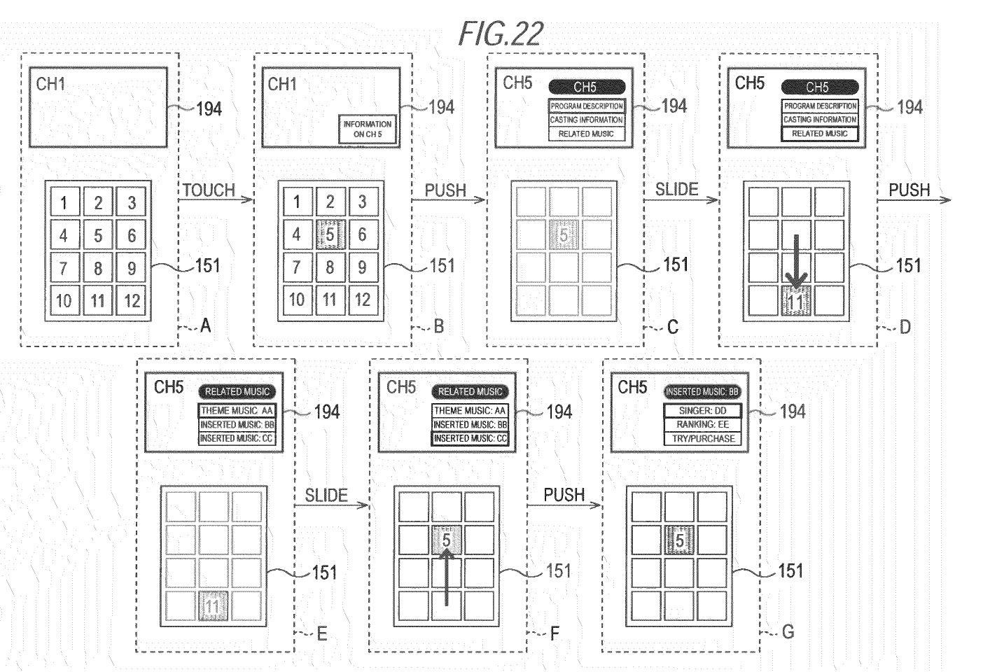

Here, the display unit 194 of the television set 132 that displays more detailed program related information will be described with reference to FIG. 22.

In FIG. 22, similarly to FIG. 17, displays of the display unit 194 of the television set 132 corresponding to operations for the input unit 151 of the remote controller 131 are denoted by states A to G.

In addition, states A to D of FIG. 22 are the same as states A to D of FIG. 17 except for displaying “ch 5” (outline character) indicating that the selection items are the program related information of the program of channel 5 on the upper side of the selection items displayed in the display unit 194. Thus, the description thereof is omitted here.

In state D of FIG. 22, when a key on which a number “11” is indicated is pushed after being slid, as shown in state E of FIG. 22, selection items used for selecting music that is related music as information on the related music are displayed on the right side of the display unit 194. In the display unit 194 of state E shown in FIG. 22, “related music” (outline character) indicating that the selection items are related music is displayed, and selection items used for selecting “theme music: AA”, “inserted music: BB”, and “inserted music: CC” are displayed as related music. In the selection items, “theme music: AA” positioned on the uppermost side is focused.

In a case where a slide for two items are performed in the upward direction in state E of FIG. 22 that is the state in which the key on which the number “11” is indicated is touched, as shown in state F of FIG. 22, the related music corresponding to the selection item to which the focus is moved in the display unit 194 is “inserted music: CC” positioned on the third from the top. At this time, the touched key is a key on which a number “5” is indicated. Thus, when the key is pushed, as shown in state G of FIG. 22, selection items used for selecting detailed information on “inserted music: CC” are displayed on the right side of the display unit 194. In the display unit 194 of state G shown in FIG. 22, “inserted music: CC” (outline character) indicating that the selection items are information on “inserted music: CC” is displayed, and selection items used for selecting “singer: DD:, “ranking: EE”, and “try/purchase” that are more detailed information on “inserted music: CC” are displayed. In the selection items, “singer: DD” disposed on the uppermost side is focused.

As described above, by configuring the program related information to have a hierarchical structure, selection items used for selecting more detailed (deep hierarchy) information on the program related information can be displayed in the display unit 194. Accordingly, the user can acquire more detailed information on a watching program.

According to the above-described process, the remote controller 131 can select the accompanying information corresponding to a selection item used for selecting the accompanying information on the content displayed in the display unit 194 of the television set 132 in accordance with only a slide input between keys of the input unit 151 disposed in the vertical direction or the horizontal direction.

The configuration of the above-described input unit 151 may be applied to either a hardware keyboard or a software keyboard. In the numeric keypad as the above-described input unit 151, even each corner key has a key located adjacent thereto. Accordingly, in a case where the input unit 151 is implemented by a software keyboard, corner keys do not need to accept a slide input in an area other than an area in which the keyboard is displayed. Therefore, an area does not need to be disposed for a slide on the periphery of the area in which the keyboard is displayed, whereby the input unit can be configured within a relatively small area. On the other hand, if the input unit 151 is implemented by a hardware keyboard, each key does not need to detect the direction of a slide. Accordingly, each key does not need to have sensors for each direction, whereby the input unit can be configured to have a relatively simple structure. In other words, an input unit that occupies a small area and has a relatively simple structure can be configured.

In addition, a user can perform a continuous operation by performing a slide input. Accordingly, the burden on a user's finger can be decreased, whereby the input speed can be raised. Furthermore, a push input does not need for selection, and accordingly, an error in the selection by mistakenly pressing down an adjacent key can be decreased.

In FIG. 15, the remote controller 131 and the television set 132 are separately configured. However, the remote controller 131 and the television set 132 may be integrally configured as one device.

In the description presented above, the channels of television broadcasts or contents such as a motion picture, a photo, and music, which are delivered through a network such as the Internet, are assigned to the keys of the remote controller 131. In addition, various applications (functions) (for example, program listing display, volume adjustment, image quality (sound quality) control, shift between display modes, and the like) relating to watching of the contents can be assigned to the keys of the remote controller 131. In such a case, by sliding a key, to which a predetermined application is assigned, after being touched, a parameter set by the application is selected.

For example, in a case where a key of the remote controller 131 to which the application of displaying a program listing is assigned is touched, a program can be selected from the program listing by displaying and sliding the program listing in the display unit 194 of the television set 132.

In addition, in a case where a key of the remote controller 131 to which the application of volume adjustment is assigned is touched, the volume can be adjusted by displaying and sliding a volume for volume adjustment in the display unit 194 of the television set 132.

Furthermore, in a case where a key of the remote controller 131 to which an application of the image quality (sound quality) control is assigned is touched, the image quality (sound quality) can be controlled by displaying and sliding an indicator for image quality (sound quality) control in the display unit 194 of the television set 132.

In addition, in a case where a key of the remote controller 131 to which an application of shifting between display modes is assigned is touched, the display mode can be changed by displaying and sliding selection items for selecting aspect ratios in the display unit 194 of the television set 132.

As presented above, an example in which the present invention is applied to a remote controller for selecting a content (program) for a mobile terminal device to which characters are input or a television set has been described. However, the present invention is not limited thereto and can be applied to a device having a function of selecting information corresponding to selection items displayed in the display unit.

Embodiments of the present invention are not limited to the above-described embodiments, and various changes can be made therein in the scope not departing from the basic concept of the present invention.

The present application contains subject matter related to that disclosed in Japanese Priority Patent Application JP 2009-154920 filed in the Japan Patent Office on Jun. 30, 2009, the entire contents of which is hereby incorporated by reference.

What is claimed is:

1. An input device that inputs information corresponding to display of a display unit, the input device comprising:
an input unit that accepts a slide input in which a contact portion moves in a predetermined direction after being touched with the contact maintained, said input unit being configured by a plurality of input mechanisms that are adjacent to each other;
slide input detecting means for detecting the slide input between the input mechanisms of the input unit; and
selection means for selecting the information corresponding to a selection item displayed in the display unit in accordance with the slide input detected by the slide input detecting means.

2. The input device according to claim 1,
wherein the plurality of input mechanisms are disposed in a matrix shape,
wherein the slide input detecting means detects a first slide input that is the slide input between the input mechanisms adjacent to each other in a predetermined direction and a second slide input that is the slide input between the input mechanisms adjacent to each other in a direction perpendicular to the predetermined direction, and
wherein the selection means selects the information corresponding to the selection items displayed in the display unit in a predetermined order when the first slide input is detected by the slide input detecting means, or selects the information corresponding to the selection items displayed in the display unit in an order opposite to the predetermined order if the second slide input is detected.

3. The input device according to claim 2,
further comprising touch input detecting means for detecting a touch input in each of the input mechanisms,
wherein the selection means selects accompanying information that corresponds to the selection items displayed in the display unit corresponding to the input mechanism in a predetermined order when the first slide input is detected, or selects the accompanying information corresponding to the selection items displayed in the display unit in an order opposite to the predetermined order if the second slide input is detected.

4. The input device according to claim 3, further comprising:
push input detecting means for detecting a push input in any of the input mechanisms; and
determination means for determining the accompanying information selected by the selection means as input information at a time when the push input is detected in the input mechanism by the push input detecting means.

5. The input device according to claim 4, wherein the determination means determines the accompanying information selected by the selection means as the input information when the touch input is released in the input mechanism.

6. The input device according to claim 4,
wherein the touch input detecting means detects the touch input in each of the input mechanisms to which a group of characters input for a character input are assigned,
wherein the selection means selects characters, which are displayed in the display unit, included in the group of characters corresponding to the input mechanism in a predetermined order when the first slide input is detected, or selects the characters included in the group of characters in an order opposite to the predetermined order if the second slide input is detected, and
wherein the determination means determines the character selected by the selection means as the input character when the push input is detected in the input mechanism.

7. The input device according to claim 4,
wherein the selection means selects conversion candidates for a character, which are displayed in the display unit, in a character input corresponding to the input mechanism in which the touch input is detected by the touch input detecting means in a predetermined order when the first slide input is detected, or selects the conversion candidates for the character displayed in the display unit in an order opposite to the predetermined order if the second slide input is detected, and
wherein the determination means determines the conversion candidate for the character that is selected by the selection means when the push input is detected in the input mechanism.

8. The input device according to claim 4,
wherein the selection means selects formats of a character, which are displayed in the display unit, set in a character input corresponding to the input mechanism in which the touch input is detected by the touch input detecting means in a predetermined order when the first slide input is detected, or selects the formats of the character in an order opposite to the predetermined order when the second slide input is detected, and
wherein the determination means determines the format of the character that is selected by the selection means when the push input is detected in the input mechanism.

9. The input device according to claim 4,
wherein the touch input detecting means detects a touch input in each of the input mechanisms to which contents are assigned,
wherein the selection means selects content related information of the content, which is displayed in the display unit, corresponding to the input mechanism in a predetermined order when the first slide input is detected, or selects the content related information displayed in the display unit in an order opposite to the predetermined order if the second slide input is detected, and
wherein the determination means determines the content related information that is selected by the selection means when the push input is detected in the input mechanism.

10. The input device according to claim 9, further comprising supply means for supplying a command for displaying the content related information of the content corresponding to the input mechanism, in which the touch input is detected, in the display unit at a time when the touch input is detected in any of the input mechanisms by the touch input detecting means.

11. The input device according to claim 10, wherein when a touch input for the predetermined time or more is detected in any of the input mechanisms the supply means supplies a command for displaying the content corresponding to the input mechanism in a predetermined area of the display unit.

12. The input device according to claim 11, wherein when a push input for the predetermined time or more is detected in any of the input mechanisms the supply means supplies a command for newly assigning the content displayed in the display unit to that input mechanism in which the push input for a predetermined time or more is detected.

13. The input device according to claim 4,
wherein the touch input detecting means detects the touch input in each of the input mechanisms to which applications relating to contents viewing are assigned,
wherein the selection means selects parameters displayed in the display unit, set by the application corresponding to the input mechanism, in a predetermined order when a first slide input is detected, or selects the parameters displayed in the display unit in an order opposite to the predetermined order if the second slide input is detected, and
wherein the determination means determines the parameter that is selected by the selection means when the push input is detected in the input mechanism.

14. An input method for an input device that inputs information corresponding to display of a display unit and includes an input unit that accepts a slide input in which a contact portion moves in a predetermined direction after being touched with the contact maintained, said input unit being configured by a plurality of input mechanisms adjacent to each other, the input method comprising the steps of:
detecting the slide input between the input mechanisms of the input unit; and
selecting the information corresponding to a selection item displayed in the display unit in accordance with the slide input detected in the detecting of the slide input.

15. An input device that inputs information corresponding to display of a display unit, the input device comprising:
an input unit that accepts a slide input in which a contact portion moves in a predetermined direction after being touched with the contact maintained, said input unit being configured by a plurality of input mechanisms that are adjacent to each other;
a slide input detecting unit configured to detect the slide input between the input mechanisms of the input unit; and
a selection unit configured to select the information corresponding to a selection item displayed in the display unit in accordance with the slide input detected by the slide input detecting unit.
